(19) United States
(12) Patent Application Publication
(10) Pub. No.: US 2025/0300278 A1
(43) Pub. Date: Sep. 25, 2025

(54) Battery Modules with Casted Module Enclosures and Methods of Fabricating Thereof

(71) Applicant: Harbinger Motors Inc., Garden Grove, CA (US)

(72) Inventors: Kenneth Kawanishi, Gardena, CA (US); Phil Gow, Gardena, CA (US); Phillip John Weicker, Hermosa Beach, CA (US); Cody Rhebergen, Gardena, CA (US); John Henry Harris, III, Anaheim, CA (US); Vu Phan, Gardena, CA (US); Michael Carl Fricke, Culver City, CA (US); Daniel McCarron, Gardena, CA (US); Deborah Bourke, San Diego, CA (US); Anna Scheibengraber, Gardena, CA (US)

(21) Appl. No.: 19/230,377

(22) Filed: Jun. 6, 2025

Related U.S. Application Data
(63) Continuation-in-part of application No. 18/591,346, filed on Feb. 29, 2024, now Pat. No. 12,355,052.
Application No. 18/591,346 is a continuation of application No. 18/462,233, filed on Sep. 6, 2023, now Pat. No. 11,961,987.
(60) Provisional application No. 63/374,708, filed on Sep. 6, 2022.
(60) Provisional application No. 63/374,712, filed on Sep. 6, 2022.

(51) Int. Cl. H01M 10/658; H01M 10/613; H01M 50/233; H01M 50/249

(52) U.S. Cl. CPC H01M 10/658; H01M 10/613; H01M 50/233; H01M 50/249; H01M 2220/20

(57) ABSTRACT

Described herein are battery packs comprising thermal sensor modules and electric vehicles using these packs. In some examples, a battery pack comprises a set of battery modules positioned within the enclosed cavity formed, in part, by a set of side walls. The thermal sensor module is positioned within a thermal sensor module opening in the set of side walls and comprises a thermal sensor module housing a thermal sleeve, and a temperature sensor positioned within and thermally coupled with the thermal sleeve. The thermal sleeve physically contacts and is thermally coupled with at least one battery cell of the set of battery modules. The thermal sensor module may comprise a thermal sensor module spring configured to urge the thermal sleeve towards the battery cell. One or more retention tab may retain the thermal module in the thermal sensor module opening during fabrication of the battery modules.

### CROSS-REFERENCE TO RELATED APPLICATIONS

This application is a continuation-in-part of U.S. patent application Ser. No. 18/591,346, entitled: “Battery Modules and Methods of Fabricating Thereof”, Docket HARBP015USC1, filed on 2024 Feb. 29, which is a continuation of U.S. patent application Ser. No. 18/462,233, entitled: “Battery Modules with Casted Module Enclosures and Methods of Fabricating Thereof”, Docket HARBP015US, filed on 2023 Sep. 6 and granted as U.S. Pat. No. 11,961,987 on 2024 Apr. 16, which claims the benefit under 35 U.S.C. § 119(e) of U.S. Provisional Patent Application 63/374,708, entitled: “BATTERY MODULES AND METHODS OF FABRICATING THEREOF”, filed on 2022 Sep. 6 and U.S. Provisional Patent Application 63/374,712, entitled: “BATTERY PACKS AND ELECTRIC VEHICLES COMPRISING THEREOF”, filed on 2022 Sep. 6, all of which are incorporated herein by reference in its entirety for all purposes.

### BACKGROUND

Electric vehicles use batteries (e.g., in the form of battery packs) to store electrical energy and to deliver this energy to various systems of the vehicle (e.g., the drivetrain for propelling the vehicles, heating-cooling systems, lights, etc.). However, integrating battery packs into electric vehicles, such as electric trucks, can be difficult because of the large space needed for these packs and the large packs' weight. For example, a 100-kWh battery pack can weigh more than 500 kg and can have a volume of more than 300 L (depending on the cell types, cooling systems, etc.). Furthermore, electric trucks have large frames that support front and rear suspension components, cabin, truck bed/cargo area, and other components/These frames limit the space available for battery packs. For example, in a frameless car (e.g., a small passenger vehicle), the battery pack can form the vehicle's floor and can be used as a structural component (e.g., a part of the unibody design). However, such options may not be fully available in larger trucks (e.g., Class 3 trucks with a gross vehicle weight rating (GVWR) of 4,540-6,350 kg, Class 4 trucks with a GVWR of 6,350-7,260 kg, Class 5 trucks with a GVWR of 7,260-8,850 kg, and Class 6 trucks with GVWR of 8,850-11,790 kg).

Overall, integrating battery packs into vehicles with frames (e.g., electric trucks) poses several challenges due to the unique characteristics and requirements of battery packs as well as the various operational and design requirements of these vehicles. One specific challenge is associated with weight distribution/the position of the vehicle's center of mass. As noted above, battery packs can be quite heavy, and their placement within electric trucks can significantly impact the weight distribution and, as a result, the vehicle's handling. Positioning battery packs above the frame raises the vehicle's center of mass, while positioning these battery packs below the frame can negatively impact the truck's road clearance and can expose the battery packs to potential damage. At the same time, integrating battery packs into a truck's frame may require modifications to the frame. Another challenge associated with using battery packs in electric vehicles is heat management. Specifically, battery packs can generate heat during their charging and discharging, while excessive temperatures can degrade battery cells and even pose safety risks. It should be noted that asphalt and concrete can often reach surface temperatures as high as 80° C. (in direct sunlight), which can act as another heat source for battery packs. At the same time, providing cooling to the battery packs fitted around the frame can be challenging. Furthermore, trucks can be subjected to greater vibrations than passenger vehicles (due to their suspension configuration to overcome higher weight variations between loaded and unloaded trucks). Trucks' frames are exposed to various elements (e.g., water, dirt, and road debris). Yet, battery packs are expected to last for many years in electric trucks while these trucks can be operated in harsh conditions. Finally, battery packs may require maintenance or replacement over time. As such, the integration (into electric trucks, e.g., around the trucks' frames) should be in a way that allows for relatively easy access to the battery packs for servicing while ensuring safety during these operations.

What is needed are new battery modules and battery packs comprising modules that can be easily integrated into electrical vehicles, such as electric trucks, and methods of fabricating such battery modules.

### SUMMARY

Described herein are battery modules and methods of fabricating thereof. In some examples, a battery module comprises an enclosure, separated into two enclosure portions and a thermal portion, positioned between the two enclosure portions. Two enclosure portions are in part defined by side walls, which can be tapered. The thermal portion comprises two thermal walls, which are operable as the bottoms of the two enclosure portions and form a thermal cavity between these thermal walls. In some examples, the enclosure is a monolithically cast component. Alternatively, the enclosure can be partially cast with one thermal wall welded thereafter to a cast subassembly. The battery module also comprises two sets of batteries, each positioned into a corresponding enclosure portion. Each battery set is interconnected with an interconnecting assembly, positioned between the battery set and the corresponding cover, for this enclosure portion.

Also described herein are battery packs and electric vehicles using these packs. In some examples, a battery pack comprises two portions/covers and a set of battery modules positioned within the enclosed cavity formed by these portions. A battery pack may comprise a set of pressure-relief valves positioned in and protruding through a wall of at least one portion. Each valve can be coaxial with a corresponding gap provided between two adjacent modules. The valve is configured to provide a fluid path (to the exterior of the battery pack) when the pressure inside the pack exceeds a set threshold. In some examples, the battery pack comprises an inlet tube fluidically coupled to the inlet port of each module and an outlet tube fluidically coupled to the outlet port of each module. A set of specially configured orifices or controllable valves is positioned on the fluid path through each module.

Also described herein are battery modules incorporating thermal sensor modules. In some examples, the battery modules comprise a first thermal wall, a first set of side walls comprising a thermal sensor module opening, a first set of battery cells, and a thermal sensor module. The first set of battery cells is thermally coupled with the first thermal wall. The thermal sensor modules are positioned within the thermal sensor module opening and comprise a thermal sensor module housing a thermal sleeve, and a temperature sensor positioned within and thermally coupled with the thermal sleeve. At least a portion of the thermal sleeve is positioned within the thermal sensor module housing and the thermal sleeve is slidably coupled with the thermal sensor module housing. The thermal sleeve physically contacts and is thermally coupled with at least one battery cell of the first set of battery cells. The thermal modules may comprise a thermal sensor module spring configured to urge the thermal sleeve towards the battery cell. One or more retention tabs may retain the thermal modules in the thermal sensor module openings during fabrication of the battery modules.

Clause 1. A battery module comprising: an enclosure comprising a first set of side walls, and a second set of side walls, a first thermal wall, and a second thermal wall, wherein: the first set of side walls and the first thermal wall define a first enclosure portion, the second set of side walls and the second thermal wall define a second enclosure portion, the thermal portion is positioned between the first enclosure portion and the second enclosure portion and is defined, at least in part, by the first thermal wall and the second thermal wall collectively forming a thermal cavity therebetween, and at least the first set of side walls, the second set of side walls, and the second thermal wall are monolithically cast as a single-cast component; a first set of batteries, positioned within the first enclosure portion, surrounded by the first set of side walls, and thermally coupled to the first thermal wall; a second set of batteries, positioned within the second enclosure portion, surrounded by the second set of side walls and thermally coupled to the second thermal wall; a first interconnecting assembly, surrounded and supported by the first set of side walls and interconnecting the first set of batteries; and a second interconnecting assembly, surrounded and supported by the second set of side walls and interconnecting the second set of batteries.

Clause 2. The battery module of clause 1, wherein the first thermal wall is not a part of the single-cast component and is attached to the first set of side walls after the single-cast component is fabricated.

Clause 3. The battery module of clause 2, wherein the first thermal wall is friction-stir welded to the first set of side walls after the single-cast component is fabricated.

Clause 4. The battery module of clause 1, wherein the first set of side walls, the second set of side walls, the first thermal wall, and the second thermal wall are monolithically cast such that the first thermal wall is a part of the single-cast component.

Clause 5. The battery module of clause 1, wherein the first set of side walls comprises an interior surface facing the first enclosure portion and forming an interior-surface angle (β) between the interior surface of the first set of side walls and the first thermal wall of greater than 90°.

Clause 6. The battery module of clause 5, wherein interior-surface angle (β) between the interior surface of the first set of side walls and the first thermal wall is between 91°-97°.

Clause 7. The battery module of clause 1, wherein the first set of side walls has a height greater than the height of the first set of batteries.

Clause 8. The battery module of clause 1, wherein: the first set of side walls comprises a top edge and an intermediate edge, each extending parallel to the first thermal wall, and the intermediate edge is positioned between the top edge and the first thermal wall and supports the first interconnecting assembly.

Clause 9. The battery module of clause 8, further comprising a first cover and a second cover, wherein: the first cover is supported on the top edge of the first set of side walls such that at least a portion of the first interconnecting assembly is positioned between the first cover and the first interconnecting assembly, and the second cover is supported on the second set of side walls such that at least a portion of the second interconnecting assembly is positioned between the second cover and the second interconnecting assembly.

Clause 10. The battery module of clause 1, wherein at least a portion of the first interconnecting assembly extends outside of the first enclosure portion and is attached to an exterior surface of the first set of side walls using a pressure sensitive adhesive.

Clause 11. The battery module of clause 1, wherein each of the first set of side walls and the second set of side walls comprises side wall openings for protruding bus bars to each of the first interconnecting assembly and the second interconnecting assembly.

Clause 12. The battery module of clause 1, wherein: the first set of side walls comprises a top edge, and the side wall openings of the first set of side walls extend to the top edge.

Clause 13. The battery module of clause 1, wherein: the first thermal wall comprises a base and an electrically insulating surface layer, positioned between the base and the first set of batteries and directly interfacing the first set of batteries, and the electrically insulating surface layer electrically insulates the base of the first thermal wall from the first set of batteries.

Clause 14. The battery module of clause 13, wherein the electrically insulating surface layer is thermally conductive epoxy, attaching the first set of batteries to the first thermal wall.

Clause 15. The battery module of clause 1, wherein: the first set of side walls comprises a top edge, the thermal portion further comprises a first fluid port and a second fluid port providing fluidic communication to the thermal cavity, and the second fluid port is positioned closer to the top edge of the first set of side walls than the first fluid port.

Clause 16. The battery module of clause 15, wherein: the thermal portion comprises a divider extending through the thermal cavity between and monolithic with each of the first thermal wall and the second thermal wall and at least partially separating the thermal cavity into a first cavity portion and a second cavity portion, the first fluid port extends into the first cavity portion, and the second fluid port extends into the first cavity portion.

Clause 17. The battery module of clause 16, wherein: the enclosure comprises a first enclosure side and a second enclosure side, the first fluid port and the second fluid port are positioned at the first enclosure side, and the divider extends to the first enclosure side and is separated by a gap from the second enclosure side.

Clause 18. The battery module of clause 1, wherein: the thermal portion comprises a set of pins extending through the thermal cavity between and monolithic with each of the first thermal wall and the second thermal wall, the set of pins is configured to enhance the thermal transfer between a thermal fluid, disposed within the thermal cavity, and each of the first thermal wall and the second thermal wall.

Clause 19. The battery module of clause 1, further comprising a first enclosure divider and a fire-retardant foam, wherein: the first set of side walls comprises a top edge, the first enclosure divider is positioned between the top edge and the first thermal wall such that the first set of battery cells protrude through the first enclosure divider, and the fire-retardant foam fills space around the first set of battery cells and between the first enclosure divider and the first cover.

Clause 20. A method of fabricating a battery module, the method comprising: die casting an enclosure subassembly comprising a first set of side walls, a second set of side walls, and a second thermal wall; friction-stir welding a first thermal wall to the first set of side walls of the enclosure subassembly thereby forming the enclosure, wherein: the first set of side walls and the first thermal wall define a first enclosure portion, the second set of side walls and the second thermal wall define a second enclosure portion, the thermal portion is positioned between the first enclosure portion and the second enclosure portion and is defined, at least in part, by the first thermal wall and the second thermal wall collectively forming a thermal cavity therebetween, and positioning a first set of batteries into the first enclosure portion enclosure such that the first set of batteries is surrounded by the first set of side walls and thermally coupled to the first thermal wall; positioning a second set of batteries into the second enclosure portion enclosure such that the second set of batteries is surrounded by the second set of side walls and thermally coupled to the second thermal wall; interconnecting the first set of batteries using a first interconnecting assembly such that, after interconnecting the first set of batteries, the first interconnecting assembly is surrounded and supported by the first set of side walls; and interconnecting the second set of batteries using a second interconnecting assembly such that, after interconnecting the second set of batteries, the second interconnecting assembly is surrounded and supported by the second set of side walls.

Clause 21. A battery pack comprising: a first portion; a second portion, attached to the first portion and forming an enclosed cavity with the first portion; a set of battery modules positioned within the enclosed cavity and separated by a set of module gaps, wherein any two adjacent modules in the set of battery modules are separated by one gap in the set of module gaps; and a set of pressure-relief valves positioned in and protruding through a wall of the first portion, wherein: each valve in the set of pressure-relief valves is configured to provide a fluid path from the enclosed cavity to the environment outside of the battery pack when the pressure inside the enclosed cavity at or exceeds a set threshold, the enclosed cavity is fluidically isolated from the environment when the pressure inside the enclosed cavity is below the set threshold, and each valve in the set of pressure-relief valves is coaxial with one gap in the set of module gaps.

Clause 22. The battery pack of clause 21, wherein each battery module in the set of battery modules comprises: an enclosure comprising a first set of side walls, and a second set of side walls, a first thermal wall, and a second thermal wall, wherein: the first set of side walls and the first thermal wall define a first enclosure portion, the second set of side walls and the second thermal wall define a second enclosure portion, the thermal portion is positioned between the first enclosure portion and the second enclosure portion and is defined, at least in part, by the first thermal wall and the second thermal wall collectively forming a thermal cavity therebetween, and at least the first set of side walls, the second set of side walls, and the second thermal wall are monolithically cast as a single-cast component; a first set of batteries, positioned within the first enclosure portion, surrounded by the first set of side walls, and thermally coupled to the first thermal wall; a second set of batteries, positioned within the second enclosure portion, surrounded by the second set of side walls and thermally coupled to the second thermal wall; a first interconnecting assembly, surrounded and supported by the first set of side walls and interconnecting the first set of batteries; and a second interconnecting assembly, surrounded and supported by the second set of side walls and interconnecting the second set of batteries.

Clause 23. The battery pack of clause 21, wherein each battery module in the set of battery modules is positioned between two gaps in the set of module gaps.

Clause 24. The battery pack of clause 23, wherein each battery module in the set of battery modules comprises two module covers, each facing one of the two gaps in the set of module gaps.

Clause 25. The battery pack of clause 23, wherein: the set of pressure-relief valves comprises a first subset of pressure-relief valves and a second subset of pressure-relief valves, the wall of the first portion comprises a first sidewall and a second sidewall, opposite the first sidewall, the first subset of pressure-relief valves is positioned in and protruding through the first sidewall, and the second subset of pressure-relief valves is positioned in and protruding through the second sidewall.

Clause 26. The battery pack of clause 25, wherein each of the first subset of pressure-relief valves and the second subset of pressure-relief valves consists of five pressure-relief valves.

Clause 27. The battery pack of clause 26, wherein the set of battery modules consists of 4 modules.

Clause 28. A battery pack comprising: a first portion; a second portion, attached to the first portion and forming an enclosed cavity with the first portion; a set of battery modules positioned within the enclosed cavity and each comprising an inlet port and an outlet port; a pack inlet tube fluidically coupled to the inlet port of each module in the set of battery modules; a pack outlet tube fluidically coupled to the outlet port of each module in the set of battery modules; and a set of flow control devices selected from the group consisting of constant-flow restrictors and controllable valves, each of the flow control devices provides a selective fluid pathway between the pack inlet tube and the inlet port or between the pack outlet tube and the outlet port.

Clause 29. The battery pack of clause 21, wherein each battery module in the set of battery modules comprises: an enclosure comprising a first set of side walls, and a second set of side walls, a first thermal wall, and a second thermal wall, wherein: the first set of side walls and the first thermal wall define a first enclosure portion, the second set of side walls and the second thermal wall define a second enclosure portion, the thermal portion is positioned between the first enclosure portion and the second enclosure portion and is defined, at least in part, by the first thermal wall and the second thermal wall collectively forming a thermal cavity therebetween, and at least the first set of side walls, the second set of side walls, and the second thermal wall are monolithically cast as a single-cast component; a first set of batteries, positioned within the first enclosure portion, surrounded by the first set of side walls, and thermally coupled to the first thermal wall; a second set of batteries, positioned within the second enclosure portion, surrounded by the second set of side walls and thermally coupled to the second thermal wall; a first interconnecting assembly, surrounded and supported by the first set of side walls and interconnecting the first set of batteries; and a second interconnecting assembly, surrounded and supported by the second set of side walls and interconnecting the second set of batteries.

Clause 30. The battery pack of clause 28, further comprising a set of module temperature probes configured to measure temperature at one or more locations in each module in the set of battery modules, wherein the set of controllable valves is controlled based on the output of the set of module thermocouples.

Clause 31. The battery pack of clause 30, further comprising a set of fluid thermocouples configured to measure the temperature of a thermal fluid entering each module in the set of battery modules and, separately, exiting each module in the set of battery modules, wherein the set of controllable valves is controlled based on the output of the set of fluid thermocouples.

Clause 32. The battery pack of clause 31, further comprising a controller configured to: receive the temperature of the thermal fluid entering each module in the set of battery modules, the temperature of the thermal fluid exiting each module in the set of battery modules, the position of each valve in the set of controllable valves, and calculate the total heat transferred from each module in the set of battery modules.

Clause 33. The battery pack of clause 32, wherein the controller is configured to control the position of each valve in the set of controllable valves based on the total heat transferred from each module in the set of battery modules.

Clause 34. An electric vehicle comprising: a vehicle frame comprising two side rails and a set of cross-members, each extending perpendicular to and interconnecting the two side rails; and a set of battery packs, enclosed within and attached to the vehicle frame, wherein: each pack in the set of battery packs comprises a first portion, a second portion, attached to the first portion and forming an enclosed cavity with the first portion, and a set of battery modules positioned within the enclosed cavity, and the second portion comprises a set of support assemblies, each positioned adjacent to one corner of the second portion and attached to one cross-member in the set of cross-members.

Clause 35. The battery pack of clause 21, wherein each battery module in the set of battery modules comprises: an enclosure comprising a first set of side walls, and a second set of side walls, a first thermal wall, and a second thermal wall, wherein: the first set of side walls and the first thermal wall define a first enclosure portion, the second set of side walls and the second thermal wall define a second enclosure portion, the thermal portion is positioned between the first enclosure portion and the second enclosure portion and is defined, at least in part, by the first thermal wall and the second thermal wall collectively forming a thermal cavity therebetween, and at least the first set of side walls, the second set of side walls, and the second thermal wall are monolithically cast as a single-cast component; a first set of batteries, positioned within the first enclosure portion, surrounded by the first set of side walls, and thermally coupled to the first thermal wall; a second set of batteries, positioned within the second enclosure portion, surrounded by the second set of side walls and thermally coupled to the second thermal wall; a first interconnecting assembly, surrounded and supported by the first set of side walls and interconnecting the first set of batteries; and a second interconnecting assembly, surrounded and supported by the second set of side walls and interconnecting the second set of batteries.

Clause 36. The electric vehicle of clause 34, wherein each support assembly in the set of support assemblies comprises: a support bracket fixedly attached to the one cross-member in the set of cross-members, and a support bushing fixedly attached to a wall of the second portion and pivotably attached to the support bracket.

Clause 37. The electric vehicle of clause 36, wherein the support bushing comprises: a rigid bushing enclosure bolted to the wall of the second portion, and an elastomeric bushing supported and surrounded by the rigid bushing enclosure.

Clause 38. The electric vehicle of clause 37, wherein the support bushing is pivotably attached to the support bracket by a support bolt that protrudes through the elastomeric bushing.

Clause 39. The electric vehicle of clause 38, wherein the support bolt extends in a direction perpendicular to each of the two side rails and the set of cross-members.

Clause 40. The electric vehicle of clause 39, wherein the support bolt extends in a direction parallel to the set of cross-members.

Clause 41. A battery module 100 comprising: an enclosure 110 comprising a first thermal wall 121, a second thermal wall 122, and a first set of side walls 130 comprising a thermal sensor module opening 251, wherein the first set of side walls 130 and the first thermal wall 121 define a first enclosure portion 115; a first set of battery cells 151, positioned within the first enclosure portion 115, surrounded by the first set of side walls 130, and thermally coupled with the first thermal wall 121; and a thermal sensor module 205 positioned within the thermal sensor module opening 251 comprising: a thermal module axis 208, a thermal sensor module housing 220, a thermal sleeve 215, at least a portion of which is positioned within the thermal sensor module housing 220, and a temperature sensor 210 positioned within and thermally coupled with the thermal sleeve 215, wherein: a thermal portion 120 is defined, at least in part, by the first thermal wall 121 and the second thermal wall 122 collectively forming a thermal cavity 180 therebetween, and the thermal sleeve 215 physically contacts and is thermally coupled with one of the first set of battery cells 151.

Clause 42. The battery module 100 of clause 41, wherein the thermal sensor module opening 251 extends through the first set of side walls 130, from outside of the enclosure 110 to the first enclosure portion 115.

Clause 43. The battery module 100 of clause 41, wherein the temperature sensor 210 is a negative temperature coefficient thermistor.

Clause 44. The battery module 100 of clause 41, wherein the temperature sensor 210 is a bead-type thermistor.

Clause 45. The battery module 100 of clause 41, wherein the temperature sensor 210 is a thermocouple.

Clause 46. The battery module 100 of clause 41, wherein the thermal sensor module 205 further comprises a thermal filler 236, physically and thermally coupled with both the thermal sleeve 215 and the temperature sensor 210.

Clause 47. The battery module 100 of clause 46, wherein the thermal filler 236 is a thermally-conductive epoxy.

Clause 48. The battery module 100 of clause 41, wherein the thermal sensor module housing 220 comprises a retention tab 240 that, when the thermal sensor module housing 220 is positioned in the thermal sensor module opening 251, applies a force to a portion of the first set of side walls 130, thereby retaining the thermal sensor module housing 220 within the thermal sensor module opening 251.

Clause 49. The battery module 100 of clause 41, wherein: the thermal sensor module housing 220 further comprises a thermal sensor module housing opening 221, the thermal sleeve 215 is positioned within the thermal sensor module housing opening 221 and is slidably coupled with the thermal sensor module housing 220, the thermal sensor module 205 further comprises a thermal sensor module spring 225 positioned within the thermal sensor module housing 220, and the thermal sensor module spring 225 is configured to urge the thermal sleeve 215 against the one of the first set of battery cells 151.

Clause 50. The battery module 100 of clause 49, wherein: the thermal sleeve 215 comprises a distal end 217 positioned outside of the thermal sensor module housing 220 and a proximal end 216 positioned opposite the distal end 217, and the proximal end 216 comprises a retention flange 218 having a diameter in a plane orthogonal to the thermal module axis 208 that is larger than a diameter of the thermal sensor module housing opening 221, thereby preventing the thermal sleeve 215 from uncoupling from the thermal sensor module housing 220 by sliding towards the distal end 217.

Clause 51. The battery module 100 of clause 50, further comprising a thermal sensor module cap 222, physically contacting the thermal sensor module housing 220 and positioned at an opposite end of the thermal sensor module housing 220 from the thermal sleeve 215.

Clause 52. The battery module 100 of clause 51, further comprising a side cover 173 physically contacting the first set of side walls 130 and at least partially overlapping the thermal sensor module 205.

Clause 53. The battery module 100 of clause 52, wherein the side cover 173 physically contacts the thermal sensor module cap 222, and the thermal sensor module spring 225 physically contacts the thermal sensor module cap 222.

Clause 54. The battery module 100 of clause 51, further comprising a second set of side walls 140, wherein: the second set of side walls 140 and the second thermal wall 122 define a second enclosure portion 116, and the second set of side walls 140 comprises an additional thermal sensor module opening 253.

Clause 55. The battery module 100 of clause 51, further comprising a first interconnecting assembly 161, surrounded and supported by the first set of side walls 130 and interconnecting the first set of battery cells 151, wherein: the first set of side walls 130 comprises a top edge 131 and an intermediate edge, each extending parallel to the first thermal wall 121, and the intermediate edge is positioned between the top edge 131 and the first thermal wall 121 and supports the first interconnecting assembly 161.

Clause 56. The battery module 100 of clause 55, further comprising a first cover 171, wherein the first cover 171 is supported on the top edge 131 of the first set of side walls 130 such that at least a portion of the first interconnecting assembly 161 is positioned between the first cover 171 and set of battery cells 151.

Clause 57. The battery module 100 of clause 55, wherein: the first interconnecting assembly 161 comprises an internal portion comprising bus bars 163 wire-bonded to cell terminals of the first set of battery cells 151, the internal portion of the first interconnecting assembly 161 is positioned within the first enclosure portion 115, surrounded by the first set of side walls 130, and the first interconnecting assembly 161 further comprises an external portion, extending outside the first enclosure portion 115 and connected to the bus bars 163.

Clause 58. The battery module 100 of clause 57, wherein the internal portion of the first interconnecting assembly 161 is surrounded and supported by the first set of side walls 130.

Clause 59. The battery module 100 of clause 57, wherein the external portion of the first interconnecting assembly 161 comprises one or more printed circuit boards 164.

Clause 60. The battery module 100 of clause 59, wherein the one or more printed circuit boards 164 are interconnected with each other and the bus bars 163 using wire bonds.

Clause 61. The battery module 100 of clause 59, wherein the one or more printed circuit boards 164 are bonded to an external surface of the first set of side walls using a pressure-sensitive adhesive.

Clause 62. The battery module 100 of clause 59, wherein: the thermal sensor module 205 further comprises a sensor wire harness 230 electrically coupled with the temperature sensor 210 and a thermal sensor connector 235 electrically coupled with the temperature sensor 210, the thermal sensor module 205 protrudes through at least one of the printed circuit boards 164, and the thermal sensor connector 235 is mechanically and electrically coupled with at least one of the printed circuit boards 164.

These and other embodiments are described further below with reference to the figures.

### BRIEF DESCRIPTION OF THE DRAWINGS

FIG. 1A is a schematic perspective view of a battery module, in accordance with some examples.

FIG. 1B is a schematic perspective view of the battery module in FIG. 1A with a cover removed showing one interconnecting assembly positioned over the one set of battery cells, in accordance with some examples.

FIG. 1C is a schematic cross-sectional view of the battery module in FIG. 1A illustrating two sets of battery cells positioned on different sides of the thermal portion, in accordance with some examples.

FIG. 1D is a cross-sectional view of a battery module enclosure without any battery cells, in accordance with some examples.

FIG. 1E is another schematic perspective view of the battery module in FIG. 1A, illustrating additional features of the two interconnecting assemblies, in accordance with some examples.

FIG. 1F is a schematic perspective view of the two interconnecting assemblies, illustrating various features of these assemblies, in accordance with some examples.

FIG. 2A is a schematic perspective view of the battery module in FIG. 1A with the interconnecting assembly removed, illustrating one set of battery cells positioned in one enclosure portion, in accordance with some examples.

FIG. 2B is a schematic perspective view of the enclosure of the battery module in FIG. 1A, in accordance with some examples.

FIG. 2C is a schematic perspective view of another example of the enclosure.

FIG. 2D is a schematic perspective view of yet another example of the enclosure in which the first thermal wall is friction-stir welded to the first set of side walls, in accordance with some examples.

FIG. 3A is a schematic cross-sectional view of the battery module in FIG. 1A, in accordance with some examples.

FIG. 3B is a top cross-sectional view of the battery module, in accordance with some examples.

FIG. 3C is a top cross-sectional view of another example of the battery module.

FIGS. 4A and 4B are top cross-sectional views of the battery module at different fabrication stages of this module, in accordance with some examples.

FIG. 5 is a process flowchart corresponding to a method of fabricating a battery module, in accordance with some examples.

FIG. 6A is a schematic perspective view of a battery pack illustrating the first portion and second portion of the pack as well as pressure-relief valves positioned on the first portion and support bushings attached to the second portion, in accordance with some examples.

FIG. 6B is a schematic perspective view of the battery pack in FIG. 6A with the first portion removed to illustrate battery modules positioned within the enclosed cavity formed by the two portions, in accordance with some examples.

FIG. 7A is a schematic side view of the battery pack in FIG. 6A, in accordance with some examples.

FIG. 7B is a schematic top view of the battery pack in FIG. 6A with the first portion removed to illustrate battery modules positioned within the enclosed cavity formed by the two portions, in accordance with some examples.

FIG. 7C is an expanded view of a part of the battery pack in FIG. 7B, which illustrates a gap between two adjacent modules and the orientation of a pressure-relief valve relative to this gap, in accordance with some examples.

FIG. 7D is a schematic top cross-sectional view of the battery pack in FIG. 6A, in accordance with some examples.

FIG. 7E is an expanded view of a part of the battery pack in FIG. 7D, which illustrates a gap between two adjacent modules, an isolation structure position in the gap, and the orientation of a pressure-relief valve relative to this gap, in accordance with some examples.

FIG. 8A is a schematic perspective view of battery modules fluidically coupled to pack inlet and outlet tubes using controllable valves, in accordance with some examples.

FIG. 8B is a schematic side view of the battery modules in FIG. 8A, in accordance with some examples.

FIG. 9 is a block diagram of an electric vehicle, illustrating various vehicle systems, in accordance with some examples.

FIG. 10A is a schematic perspective view of an electric vehicle comprising a frame and a set of battery packs, enclosed within and attached to the frame, in accordance with some examples.

FIG. 10B is a schematic top view of a portion of the vehicle frame and one battery pack in FIG. 10A.

FIG. 10C is a schematic perspective view of a support assembly used for attaching a battery pack to a vehicle frame, in accordance with some examples.

FIG. 10D is a schematic side view of a support bushing, which is a part of the support assembly in FIG. 10C.

FIG. 10E is a schematic top view of another example of a battery pack, in accordance with some examples.

FIG. 10F is a schematic perspective view of another example of a support assembly used for attaching the battery pack to a vehicle frame, in accordance with some examples.

FIG. 11A is a schematic perspective view of a frame and a set of battery packs, with two packs stacked in the front portion of the frame, in accordance with some examples.

FIG. 11B is a schematic side view of the frame and two stacked battery packs of FIG. 11A, in accordance with some examples.

FIG. 11C is a schematic front view of the frame and two stacked battery packs of FIG. 11A, in accordance with some examples.

FIG. 12A is a schematic perspective view of a battery module showing one thermal sensor module installed in one thermal module sensor opening, in accordance with some examples.

FIG. 12B is a schematic perspective view of the battery module of FIG. 12A with a first cover installed, in accordance with some examples.

FIG. 12C is a schematic cross-sectional view of the battery module in FIG. 1A illustrating thermal sensor module openings and two sets of battery cells positioned on different sides of the thermal portion, in accordance with some examples.

FIG. 12D is a cross-sectional view of a battery module enclosure without any battery cells, in accordance with some examples.

FIGS. 12E-F are other schematic perspective views of the battery module in FIG. 1A, illustrating additional features of the two interconnecting assemblies, in accordance with some examples.

FIG. 12G is a schematic perspective view of the battery module of FIG. 12A with a first side cover and a second side cover installed, in accordance with some examples.

FIG. 13A is perspective view of a thermal sensor module, in accordance with some examples.

FIG. 13B is a cross-sectional perspective view of the thermal sensor module of FIG. 13A, in accordance with some examples.

FIGS. 13C-D are cross-sectional views of the battery module of FIG. 1A showing one thermal sensor module installed in one thermal module sensor opening and a first side cover installed, in accordance with some examples.

FIGS. 14A-F are cross-sectional side views of thermal sleeves of the thermal sensor module, in accordance with some examples.

FIG. 15 is a process flowchart corresponding to a method of fabricating a battery module, in accordance with some examples.

### DETAILED DESCRIPTION

In the following description, numerous specific details are outlined to provide a thorough understanding of the presented concepts. The presented concepts may be practiced without some or all of these specific details. In other instances, well-known process operations have not been described in detail to not unnecessarily obscure the described concepts. While some concepts will be described in conjunction with the specific embodiments, it will be understood that these embodiments are not intended to be limiting.

### Battery Module Examples

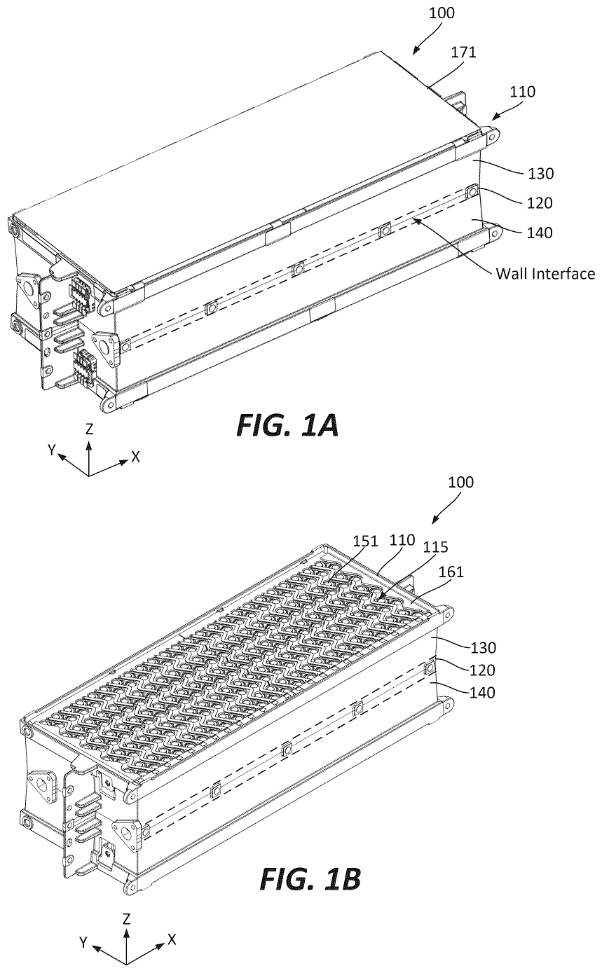

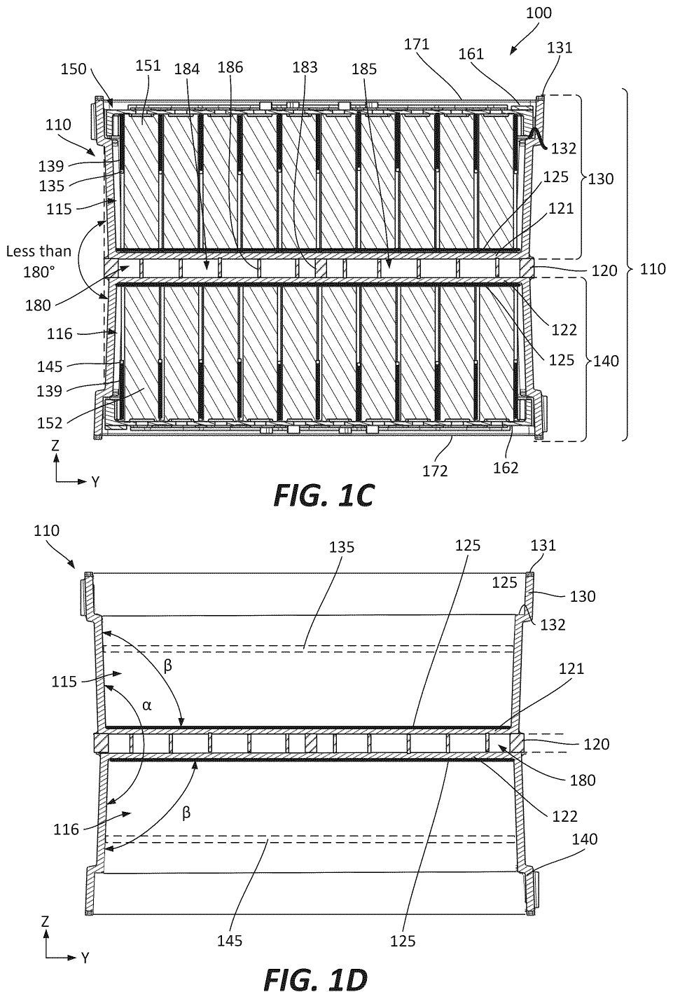

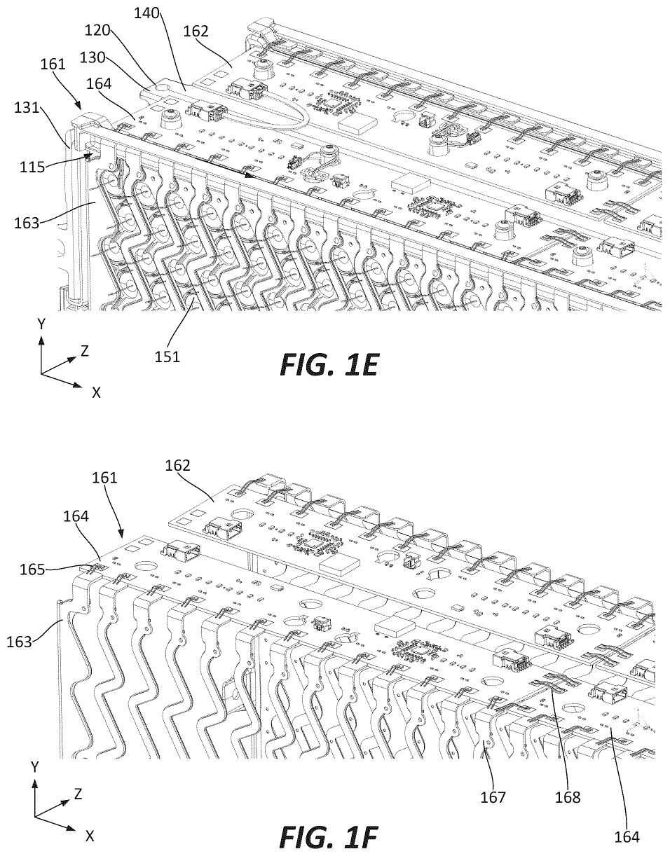

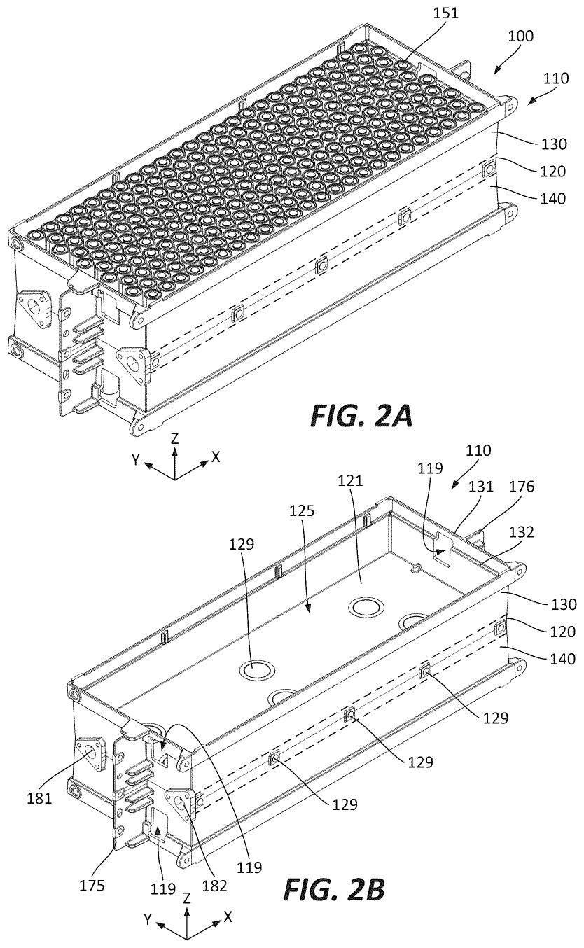

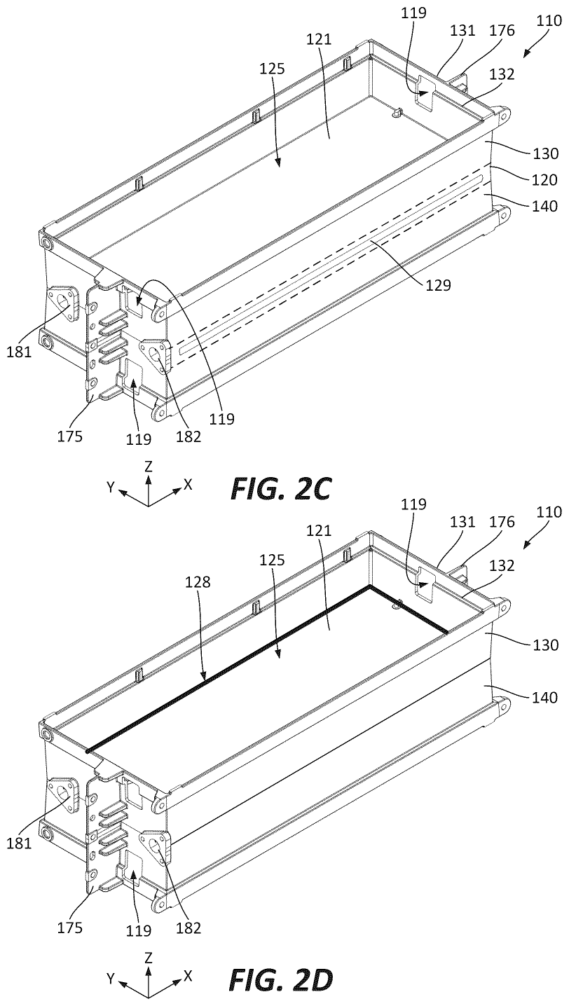

FIG. 1A is a schematic perspective view of battery module 100, in accordance with some examples. Specifically, battery module 100 comprises enclosure 110 formed by a first set of side walls 130 and a second set of side walls 140 as well as first cover 171 and second cover 172. The entire enclosure 110 can be formed from aluminum. Referring to FIGS. 1B, 1C, and 1D, enclosure 110 comprises a first enclosure portion 115 and a second enclosure portion 116, separated by a thermal portion 120. Specifically, the first enclosure portion 115 is defined by the first set of side walls 130. The first enclosure portion 115 is used to enclose a first set of battery cells 151 (e.g., shown in FIG. 2A) and can be sealed with the first cover 171. The second enclosure portion 116 is defined by the second set of side walls 140. The second enclosure portion 116 is used to enclose a second set of battery cells 152 and can be sealed with the first cover 172. The first set of battery cells 151 and the second set of battery cells 152 are collectively referred to as battery cells 150. As shown in FIGS. 1A-1D, first set of battery cells 151 and/or second set of battery cells 152 can include cylindrical battery cells (e.g., 18650 cells, 21700 cells, 30700 cells, 4680 cells). However, other types of battery cells are within the scope.

Referring to FIGS. 1B, 1C, and 1D, thermal portion 120 is positioned between first enclosure portion 115 and second enclosure portion 116 and comprises first thermal wall 121 and second thermal wall 122 as well as thermal cavity 180. Specifically, the first thermal wall 121 separates the thermal cavity 180 from the first enclosure portion 115, while the second thermal wall 122 separates the thermal cavity 180 from the second enclosure portion 116. The first thermal wall 121 provides a thermal pathway from the first set of battery cells 151 to the cooling liquid within the thermal cavity 180. Similarly, the second thermal wall 122 provides a thermal pathway from the second set of battery cells 152 to the cooling liquid within the thermal cavity 180. Overall, the first set of battery cells 151 is positioned within the first enclosure portion 115, surrounded by the first set of side walls 130, and thermally coupled to the first thermal wall 121. The second set of battery cells 152 is positioned within the second enclosure portion 116, surrounded by the second set of side walls 140, and thermally coupled to the second thermal wall 122.

The X-Y boundary of thermal portion 120 is defined by the first set of side walls 130 and the second set of side walls 140 (along the Z-axis). In other words, the first set of side walls 130 and the second set of side walls 140 are parts of the first enclosure portion 115, the second enclosure portion 116, and the thermal cavity 180. The first set of side walls 130 and the second set of side walls 140 are joined at thermal cavity 180 (shown as a “wall interface” in FIG. 1A). Overall, thermal cavity 180 is formed by the first thermal wall 121, the second thermal wall 122, the first set of side walls 130, and the second set of side walls 140.

In some examples, the entire enclosure 110 is a monolithically cast component. In other words, there are no joining seams (e.g., weld seams) and joining structures (e.g., brackets) between different components of enclosure 110, such as between the first thermal wall 121, the second thermal wall 122, the first set of side walls 130, and the second set of side walls 140. In other words, the first thermal wall 121, the second thermal wall 122, the first set of side walls 130, and the second set of side walls 140 are all formed in the same casting operation forming one monolithically cast component comprising these elements. The thermal cavity 180 is also formed/defined during this operation. Forming the enclosure 110 as a single monolithically cast component helps to simplify the fabrication process (e.g., by reducing the number of operations), reduce the total weight of the enclosure 110, and improve the structural integrity of the enclosure 110.

Alternatively, at least the first thermal wall 121 can be friction-stir welded to the first set of side walls 130 as further described below with reference to FIG. 2D. The second thermal wall 122, the first set of side walls 130, and the second set of side walls 140 can still all be formed in the same metal casting operation thereby forming one monolithically cast component comprising these elements. At this point, the thermal cavity 180 is not yet formed/defined since the first thermal wall 121 is not present. The first thermal wall 121 can be formed in a separate casting operation and later friction-stir welded to the first set of side walls 130. This example casting-welding sequence allows simplifying the metal casting process of various features inside the battery cells 150.

Referring to FIG. 1C, in some examples, the exterior surfaces of the first set of side walls 130 and the second set of side walls 140 form an angle that is less than 180° or, more specifically, less than 176° or even less than 174° around the perimeter of enclosure 110. The corner defined by this angle is the interface between the first set of side walls 130 and the second set of side walls 140, which can coincide with a middle plane through the thermal portion 120/the thermal cavity 180. As such, the exterior surfaces of the first set of side walls 130 and the second set of side walls 140 do not extend along a straight line (shown with a dotted line in FIG. 1C).

This exterior-surface angle also corresponds to an interior-surface angle (α) as shown in FIG. 1D. For example, the interior surfaces of the first set of side walls 130 and the second set of side walls 140 form an interior-surface angle (α) that is greater than 180° or, more specifically, greater than 182° or even greater than 184° around the perimeter of enclosure 110. It should be noted that this interior-surface angle (α) also corresponds to an angle (β) between the interior surface of the first set of side walls 130 and the first thermal wall 121 (or between the interior surface of the second set of side walls 140 and the second thermal wall 122), which can be greater than 90° or, more specifically, greater than 92° or even greater than 94°. For example, these interior-surfaces-to-thermal-walls angles (β) can be 91°-97° or, more specifically, 93°-95°.

These angles correspond to the first set of side walls 130 forming a tapered-shaped first enclosure portion 115 over the first thermal wall 121. Similarly, the second set of side walls 140 forms a tapered-shaped second enclosure portion 116 over the second thermal wall 122. As such, the opening of the first enclosure portion 115 can be larger than the portion of the first thermal wall 121 (at the bottom of the first enclosure portion 115) thereby enabling additional access to the first set of battery cells 151 (proximate to this opening) to install/interconnect the battery cells. Similarly, the opening of the second enclosure portion 116 can be larger than the portion of the second thermal wall 122 (at the bottom of the second enclosure portion 116) thereby enabling additional access to the second set of battery cells 152 (proximate to this opening) to install/interconnect the battery cells. This access can also be used, e.g., for mounting a first interconnecting assembly 161 and a second interconnecting assembly 162.

Referring to FIG. 1C, in some examples, the first set of side walls 130 has a height (in the Z-direction) greater than the height of the first set of battery cells 151. This approach allows the use of the first set of side walls 130 for mounting additional components without interfering with the first set of battery cells 151. With reference to FIGS. 1C and 1D, in some examples, the first set of side walls 130 comprises a top edge 131 and an intermediate edge 132, each extending parallel to the first thermal wall 121. The intermediate edge 132 is positioned between the top edge 131 and the first thermal wall 121 and can be used to support the first interconnecting assembly 161. As shown in FIG. 1C, the intermediate edge 132 can be positioned closer to the first thermal wall 121 than the plane defined by battery cell contacts. The first interconnecting assembly 161 may comprise protrusion extending from the battery-cell-contact plane and engaging the intermediate edge 132 of the first set of side walls 130.

Referring to FIG. 1C, in further examples, the battery module 100 further comprises a first cover 171 and a second cover 172. The first cover 171 is supported on the top edge 131 of the first set of side walls 130 and protects the first interconnecting assembly 161. The second cover 172 is supported on the second set of side walls 140, e.g., using a similar edge, and protects the second interconnecting assembly 162.

Referring to FIGS. 1C and 1D, in some examples, battery module 100 comprises a first enclosure divider 135 and a second enclosure divider 145, which are optional components. For example, a portion of the first enclosure portion 115 between the first enclosure divider 135 and the top edge 131 (or, more specifically, the first cover 171 when the first cover 171 is installed) is filled with fire-retardant foam 139 (e.g., a silicone foam having a fire-retardant filler particle). In some examples, the distance between the first enclosure divider 135 and the top edge 131 is 10-40 millimeters or, more specifically, 15-30 millimeters. Similarly, a portion of the second enclosure portion 116 between the second enclosure divider 145 and the top edge of the second set of side walls 140 (or the second cover 172) is filled with fire-retardant foam 139. The first enclosure divider 135 and second enclosure divider 145 reduce the amount of fire-retardant foam 139 needed in each battery module 100 thereby reducing the cost and weight of the battery module 100. It should be noted that the fire-retardant foam 139 protects the most critical part of battery cells 150, e.g., the cell caps comprising cell terminals, and wire bonding connections to these cells.

As noted above, in some examples, battery module 100 comprises a first interconnecting assembly 161, surrounded and supported by the first set of side walls 130 and interconnecting the first set of battery cells 151. Specifically, the first interconnecting assembly 161 is positioned between the first set of battery cells 151 and the first cover 171. The first cover 171 protects the first interconnecting assembly 161. In more specific examples, the battery module 100 also comprises the second interconnecting assembly 162, surrounded and supported by the second set of side walls 140 and the interconnecting second set of battery cells 152.

FIG. 1E is another example of interconnecting assemblies that extend outside of their respective enclosure portions. FIG. 1F is a schematic perspective view of the two interconnecting assemblies in FIG. 1E without the module enclosure and battery cells. Specifically, a portion of the first interconnecting assembly 161 is positioned within the first enclosure portion 115 together with the first set of battery cells 151. This portion of the first interconnecting assembly 161 comprises bus bars 163, which are wire-bonded to the cell terminals. Another portion of the first interconnecting assembly 161 extends outside the first enclosure portion 115 and extends over the external surface of one long side wall of the first set of side walls 130. FIG. 1E also illustrates a similar portion of the second interconnecting assembly 162 extending outside the second enclosure portion 116 and over the external surface of one long side wall of the second set of side walls 140.

This external portion of the first interconnecting assembly 161 may be in the form of a printed circuit board 164 (or multiple printed circuit boards (PCBs) as shown in FIGS. 1E and 1F) and may be connected to bus bars 163 using wire bonds 165. These printed circuit boards 164 can be bonded to the external surface of the first set of side walls 130 and the second set of side walls 140 using a pressure-sensitive adhesive (PSA). The PSA eliminates the need for the fastener. For example, the wire-bonding process can distort the printed circuit board 164 or at least shift this position, while the PSA can help to provide more uniform support (across the entire plane rather than point supports available with fasteners. It should be noted that a PCB can be quite flexible in the out-of-plane direction, and such uniform support can be essential to preserve all connections.

When multiple printed circuit boards 164 are used, these multiple printed circuit boards 164 can be interconnected through a common bus bar 167 and/or PCB links 168. Printed circuit boards 164 can be used to perform various functions of the battery management system at the module level. Additional battery management systems can be provided at the battery pack and/or vehicle levels. For example, printed circuit boards 164 are used for individual voltage measurements at each bus bar 163.

Referring to FIG. 2B, in some examples, each of the first set of side walls 130 and the second set of side walls 140 comprises side wall openings 119 for protruding bus bars to each of the first interconnecting assembly 161 and the second interconnecting assembly 162. A pair of side wall openings 119 can be used to provide access to the first interconnecting assembly 161 positioned in the first enclosure portion 115. These side wall openings 119 may be positioned on the opposite (smaller) sides of the first set of side walls 130. Another pair of side wall openings 119 can be used to provide access to the second interconnecting assembly 162 positioned in the second enclosure portion 116. These side wall openings 119 may be positioned on the opposite (smaller) sides of the second set of side walls 140. In some examples, side wall openings 119 are not enclosed openings (e.g., as shown in FIG. 2B) but instead are slot openings extending to the top edge 131 of the first set of side walls 130 (and a similar edge of the second set of side walls 140). The slot openings simplify the installation of bus bars for interconnecting this battery module 100 with other modules in a battery pack. In some examples, the bus bars are parts of the first interconnecting assembly 161 and/or the second interconnecting assembly 162.

Referring to FIG. 2B, in some examples, enclosure 110 further comprises a first support bracket 175 and a second support bracket 176 positioned on opposite sides of enclosure 110. The first support bracket 175 and the second support bracket 176 extend across and are monolithic with both the first set of side walls 130 and the second set of side walls 140. The first support bracket 175 and the second support bracket 176 are used to support module 100 within a battery pack.

Referring to FIG. 1D, in some examples, the first thermal wall 121 comprises an electrically insulating surface layer 125, forming the bottom of the first enclosure portion 115 and directly interfacing with the first set of battery cells 151 (when these cells are positioned within the first enclosure portion 115 as shown in FIG. 1C). For example, the base of the first thermal wall 121 can be formed from aluminum, while electrically insulating surface layer 125 can be formed using polymer, plastic, or other suitable material. The thickness of the layer may be minimal to ensure electrical isolation while minimizing the heat flux resistance between the first set of battery cells 151 and the cooling liquid within the thermal cavity 180. The second thermal wall 122 may comprise a similar electrically insulating surface layer 125, forming the bottom of the second enclosure portion 116 and directly interfacing with the second set of battery cells 152. In some examples, the electrically insulating surface layer 125 is formed by thermally conductive epoxy, which also bonds and supports the battery cells 150 relative to the corresponding thermal wall.

Referring to FIGS. 2B-2C, in some examples, the enclosure is formed as a single-cast monolithic component such that the thermal portion 120 comprises at least two post-cast plugs 129 positioned on opposite sides of enclosure 110. These post-cast plugs 129 are used to seal openings that are left from supporting rods protruding to a dissolvable core, which are used to form the thermal cavity 180 while metal casting the enclosure 110. The post-cast plugs 129 can be parts of the side walls and/or parts of the first thermal wall 121, e.g., as shown in FIG. 2B (and parts of the second thermal wall 122, which is not visible in FIG. 2B). Referring to FIG. 2C, in some examples, post-cast plugs 129 are only parts of the side walls, but not of the first thermal wall 121 or the second thermal wall 122. The first thermal wall 121 and the second thermal wall 122 can be free from any plugs (e.g., can be a continuous monolithic structure). In these examples, wherein post-cast plugs 129 are only parts of the side walls, post-cast plugs 129 can have an elongated shape (e.g., as shown in FIG. 2C). This shape is determined by the structures used to support a dissolvable core. When present, post-cast plugs 129 can be welded (e.g., friction-stir welded) into respective components of the enclosure 110.

Referring to FIG. 2D, in some examples, enclosure 110 does not have any post-cast plugs 129. Instead of using a dissolvable core, enclosure 110 is cast without the first thermal wall 121 (which can be cast separately). The first thermal wall 121 is then welded (e.g., friction-stir welded) to the first set of side walls 130, e.g., forming a friction-stir weld 128.

Referring to FIG. 2B-2D, in some examples, thermal portion 120 further comprises a first fluid port 181 and a second fluid port 182 providing fluidic communication to the thermal cavity 180. For example, the first fluid port 181 can be operable as an inlet port for a thermal fluid to enter thermal cavity 180, while the second fluid port 182 can be operable as an outlet for thermal fluid to exit thermal cavity 180. In more specific examples, the second fluid port 182 is positioned closer to the top edge 131 of the first set of side walls 130 than the first fluid port 181 thereby reducing the trapping of bubbles inside thermal cavity 180 when filling thermal cavity 180 with the thermal fluid.

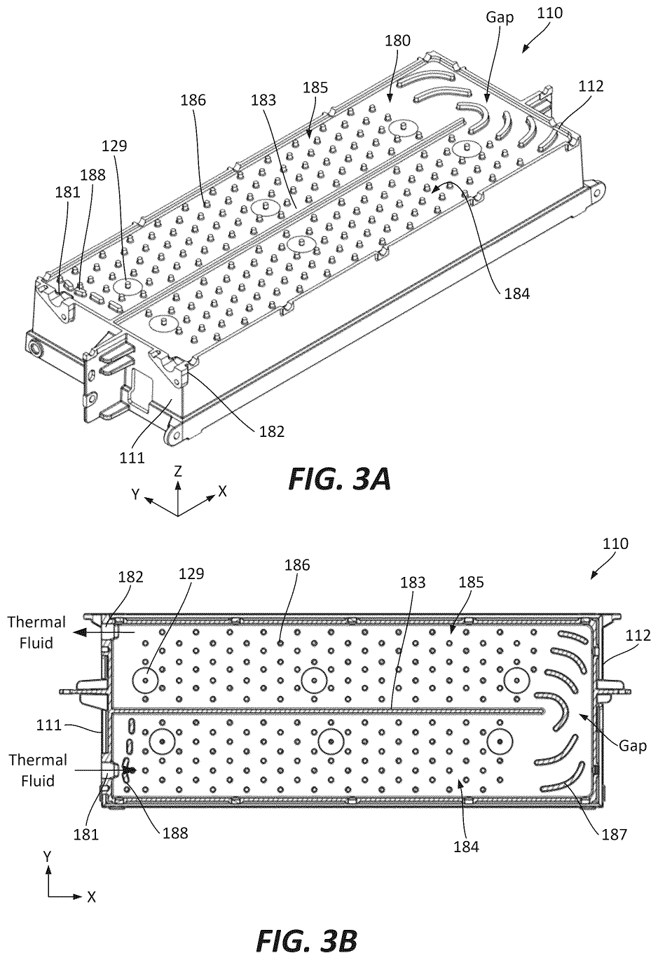

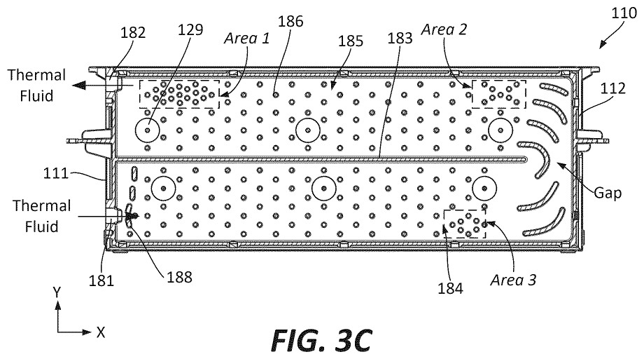

Referring to FIGS. 3A-3C, in some examples, thermal portion 120 comprises a divider 183 extending through thermal cavity 180 between the first thermal wall 121 and the second thermal wall 122. The divider 183 is monolithic with the second thermal wall 122 and, in some examples (e.g., described above with reference to FIGS. 2B and 2C) with the first thermal wall 121. Alternatively, the first thermal wall 121 may contact, may be sealed against, or maybe even welded to the first thermal wall 121 (e.g., when the first thermal wall 121 is not a part of the remaining enclosure casting).

Referring to FIG. 3A-3C, divider 183 at least partially separates thermal cavity 180 into the first cavity portion 184 and a second cavity portion 185. The first fluid port 181 extends into the first cavity portion 184, while the second fluid port 182 extends into the second cavity portion 185. Specifically, the first fluid port 181 and second fluid port 182 are positioned on the same side of the enclosure (i.e., first enclosure side 111). Specifically, enclosure 110 comprises a first enclosure side 111 and a second enclosure side 112. The divider 183 extends to the first enclosure side 111 and is separated by a gap from the second enclosure side 112 thereby providing a fluid path between the first cavity portion 184 and the second cavity portion 185 within the thermal cavity 180. A combination of the divider 183 and the gap allows the positioning of both fluid ports on the same side while circulating the thermal fluid through the entire thermal cavity 180. In some examples, the first thermal wall 121 and/or the second thermal wall 122 comprise flow diffusers 188 to control the distribution of thermal fluid and promote more even thermal fluid velocity through the thermal cavity 180 by distributing flow of the thermal fluid over the width of the first cavity portion 184. Without the flow diffusers 188, there would be a faster fluid velocity (and higher corresponding heat transfer) locally downstream of the first fluid port 181. The flow diffusers 188 may improve distribution of the thermal fluid, promoting more uniform flow, heat transfer, and temperature for battery cells thermally coupled with the first thermal wall 121 and/or the second thermal wall 122.

In some examples, the first thermal wall 121 and/or the second thermal wall 122 comprise flow redirectors 187 to direct the flow from the first cavity portion 184 to the second cavity portion 185 through the gap. Specifically, the thermal fluid flows in the direction of the X-axis in the first cavity portion 184 from the first enclosure side 111 to the second enclosure side 112. The flow redirectors 187 then redirect the fluid in the direction of the Y-axis and through the gap. The flow redirectors 187 then again redirect the fluid in the direction opposite of the X-axis when the fluid enters the second cavity portion 185. Finally, the thermal fluid flows through the second cavity portion 185 from the second enclosure side 112 to the first enclosure side 111.

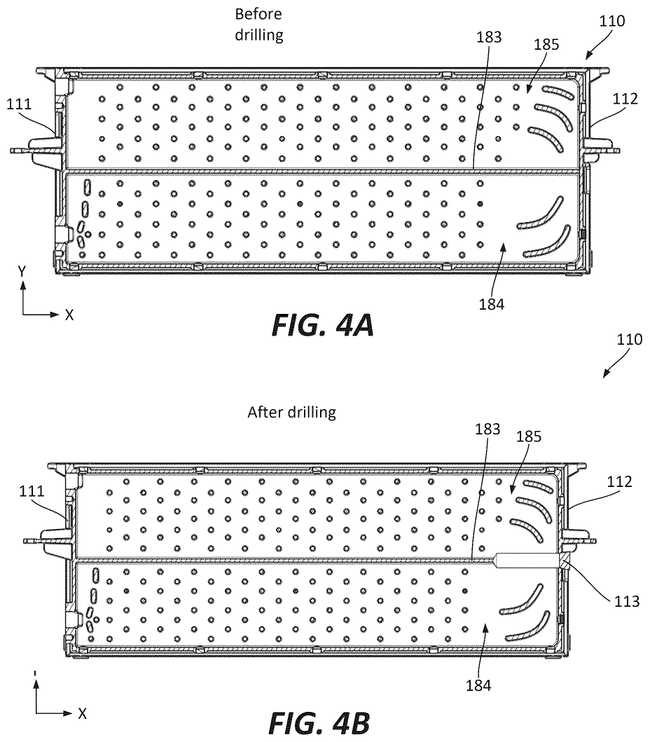

In some examples, when enclosure 110 is a monolithically cast component, enclosure 110 may initially (right after the casting) have a divider 183 that extends between the first enclosure side 111 and the second enclosure side 112, e.g., as schematically shown in FIG. 4A. In other words, at this stage, the first cavity portion 184 and the second cavity portion 185 are fluidically isolated from each other. This approach relies on two dissolvable cores when casting enclosure 110 thereby simplifying the casting process. One of these cores forms the first cavity portion 184, while the other core forms the second cavity portion 185.

The fluidic communication between the first cavity portion 184 and the second cavity portion 185 is provided by drilling out a portion of divider 183 to form a gap between the divider 183 and the second enclosure side 112. A side plug 113 may be then installed into the opening in the second enclosure side 112, formed during this drilling, e.g., as schematically shown in FIG. 4B. As such, in some examples, the second enclosure side 112 has a side plug 113 coaxial with the divider 183.

Referring to FIGS. 3A-C, in some examples, the thermal portion 120 comprises a set of pins 186 extending through the thermal cavity 180 between the first thermal wall 121 and the second thermal wall 122. In some examples, these pins 186 are monolithic with the second thermal wall 122. In more specific examples, these pins 186 are also monolithic with the first thermal wall 121. Alternatively, these pins 186 may extend and even contact the first thermal wall 121 but not join the first thermal wall 121. These pins 186 can help to intermix/create some turbulence with the thermal fluid and to transfer heat between this thermal fluid (provided in the thermal cavity 180) and the battery cells 150 during the operation of the battery module 100. Specifically, all these pins 186 increase the contact surface with the thermal fluid. Referring to FIG. 3C, in some examples, pins 186 has a non-uniform spatial density within thermal cavity 180 determined by the temperature, expected in each battery of the first set of battery cells 151 and the second set of battery cells 152. For example, the concentration of pins 186 can be proportional to the current through the battery cells 150 positioned in the same projection.

### Examples of Fabricating Battery Modules

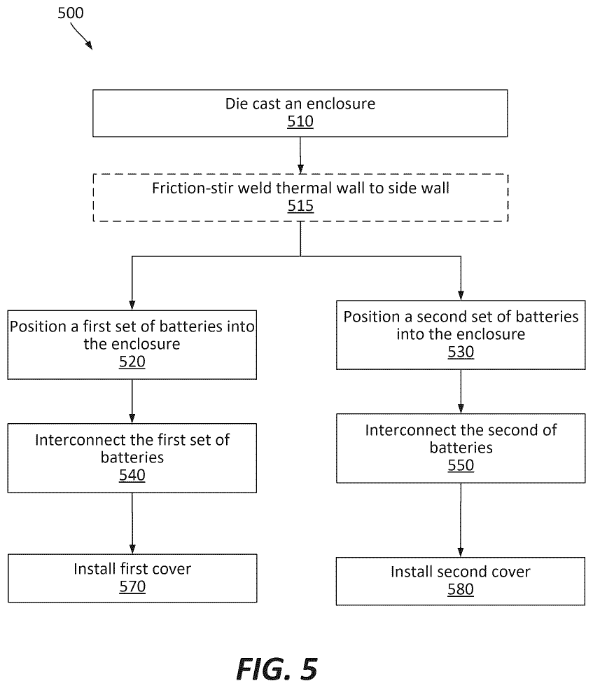

FIG. 5 is a process flowchart corresponding to method 500 of fabricating a battery module 100, in accordance with some examples. Various examples of battery module 100 are described above with reference to FIGS. 1A-3C.

In some examples, method 500 comprises (block 510) die casting an enclosure 110 a first set of side walls 130, a second set of side walls 140, and a second thermal wall 122. In some examples, this die-casting operation also forms a first thermal wall 121. For example, a casting tool may have one or more dissolvable cores to form a thermal cavity 180. These cores are removed (after the casting) to free up the thermal cavity 180. When multiple dissolvable cores are used, different portions of the thermal cavity 180 may be interconnected as described above with reference to FIGS. 4A and 4B.

Alternatively, the first thermal wall 121 is not formed as a part of this die-casting operation (block 510). Instead, the first thermal wall 121 is formed in a separate operation and later attached to the first set of side walls 130. For example, method 500 may comprise (block 515) friction-stir welding the first thermal wall 121 to the first set of side walls 130 thereby forming the thermal cavity 180 during this welding operation.

In some examples, method 500 comprises forming insulating surface layers 125 on the external surfaces of the first thermal wall 121 and the second thermal wall 122. For example, plastic sheets may be positioned over these walls. Alternatively, insulating surface layers 125 may be provided in the form of a thermally-conductive epoxy and used to bond the battery cells 150 to their respective thermal walls.

Method 500 may proceed with (block 520) positioning a first set of battery cells 151 into the enclosure 110 or, more specifically, into the first enclosure portion 115. After this operation, the first set of battery cells 151 is surrounded by the first set of side walls 130, which protrude above the first set of battery cells 151. Furthermore, the first set of battery cells 151 is thermally coupled to the first thermal wall 121.

Method 500 may also comprise (block 530) positioning a second set of battery cells 152 into enclosure 110 or, more specifically, into the second enclosure portion 116. After this operation, the second set of battery cells 152 is surrounded by the second set of side walls 140 and thermally coupled to the second thermal wall 122.

Method 500 may proceed with (block 540) interconnecting the first set of battery cells 151 using a first interconnecting assembly 161. Specifically, at least a portion of the first interconnecting assembly 161 can be inserted into the first enclosure portion 115 and, in some examples, attached to the intermediate edge 132 of the first set of side walls 130. As such, this portion of the first interconnecting assembly 161 is surrounded and supported by the first set of side walls 130. The electrical leads of the first interconnecting assembly 161 can be then connected to the electrical terminals of each battery cell in the first set of battery cells 151. The configuration of conductive traces in the first interconnecting assembly 161 determines the connection scheme among the cells. Method 500 also comprises (block 550) interconnecting the second set of battery cells 152 using a second interconnecting assembly 162. This operation can be similar to the one described above with reference to block 540. In some examples, method 500 further comprises (block 570) installing the first cover 171 and (block 580) installing the second cover 172.

### Battery Pack Examples

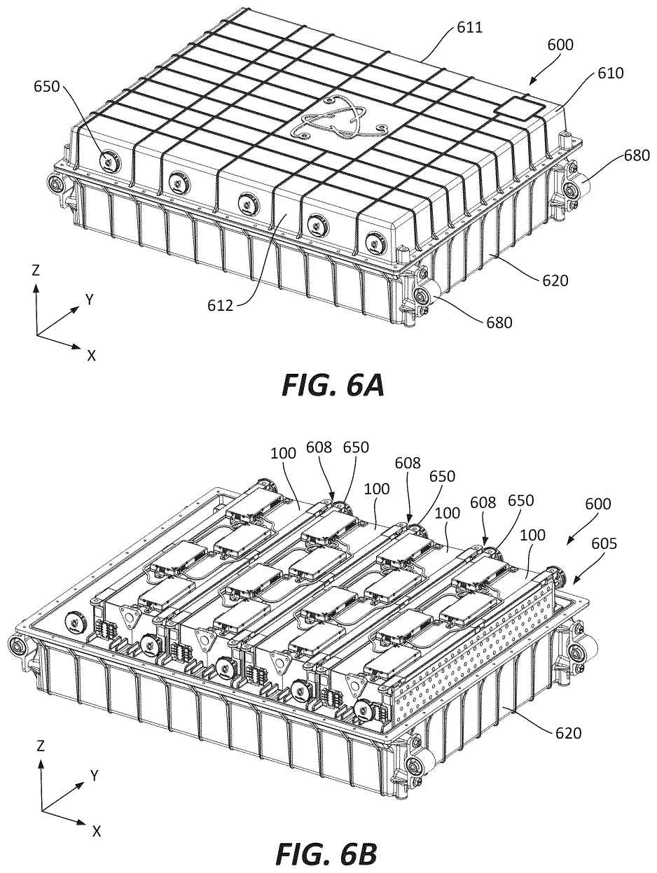

Referring to FIGS. 6A and 6B, in some examples, a battery pack 600 comprises a first battery-pack portion 610 and a second battery-pack portion 620. The first battery-pack portion 610 and second battery-pack portion 620 may be also referred to as batter-pack shells, pack-enclosure portions, and the like. The second battery-pack portion 620 can be attached (e.g., sealably attached) to the first battery-pack portion 610 such that the two portions form an enclosed pack cavity 605.

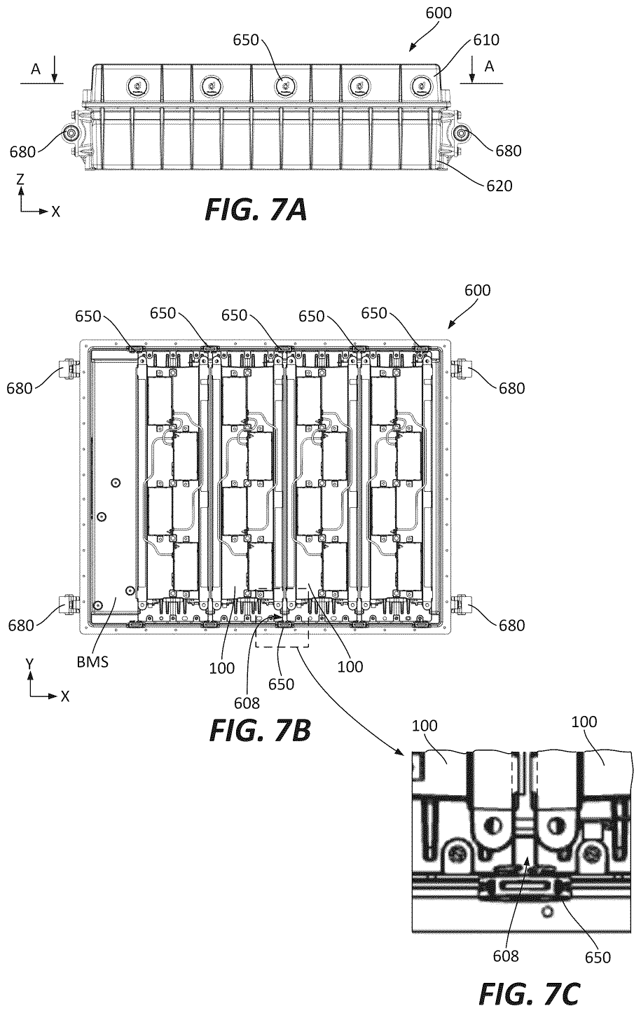

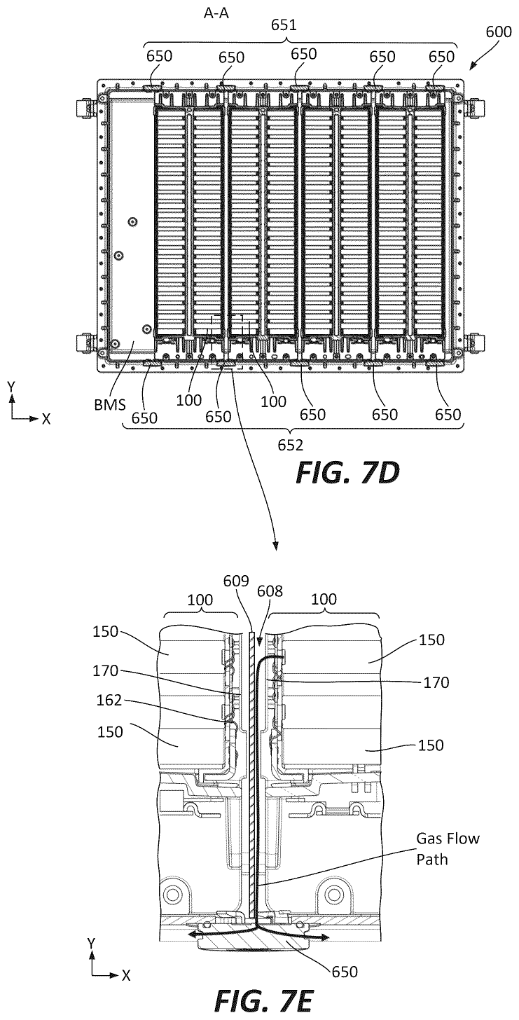

Battery pack 600 also comprises a set of battery modules 100 positioned within enclosed pack cavity 605. Various examples of battery module 100 are described above with reference to FIGS. 1A-3C. Each pair of adjacent battery modules 100 is separated by a module gap 608. Furthermore, a module gap 608 can also extend between a battery module 100 and any other components of the battery pack 600, a BMS module, the interior surface of the first battery-pack portion 610, and the interior surface of the second battery-pack portion 620. These module gap 608 are further described below with reference to FIGS. 7A-7E. Specifically, these module gaps 608 can be used to evacuate any gases generated during a thermal event in one or more of battery modules 100. Referring to FIG. 7E, in some examples, an insulation structure 609 is positioned in each module gap 608.

### Examples of Pressure-Relief Valves in Battery Packs

Referring to FIGS. 6A and 6B, in some examples, the battery pack 600 comprises a set of pressure-relief valves 650 positioned in and protruding through the wall of the first battery-pack portion 610. In specific examples, all pressure-relief valves 650 are positioned on the same portion, i.e., the first battery-pack portion 610. Alternatively, a subset of the pressure-relief valves 650 is also positioned on the second battery-pack portion 610.

Each pressure-relief valve 650 is configured to provide a fluid path from the enclosed pack cavity 605 to the environment outside of the battery pack 600 when the pressure inside enclosed pack cavity 605 is at or exceeds a set threshold. On the other hand, enclosed pack cavity 605 is fluidically isolated from the environment when the pressure inside enclosed pack cavity 605 is below the set threshold. As such, water and other environmental elements are not able to enter the pack cavity 605 and the battery pack 600 remains sealed.

This pressure (inside the enclosed pack cavity 605) can increase due to a thermal event in one or more cells (positioned inside one or more of the battery modules 100). The thermal event can be triggered by the internal/external short, overcharge, and the like. The thermal event can cause these cells to release gases thereby pressurizing the enclosed pack cavity 605. Without the pressure release, the battery pack 600 can be severely damaged and cause damage to surrounding structures, e.g., an electric vehicle. It should be noted that the speed with which the gases are delivered from the battery cells 150 to the pressure-relief valves 650 is important to reduce any internal damage to the battery pack 600 (e.g., propagate this thermal event to other battery modules 100 and/or battery cells 150).

In some examples, each pressure-relief valve 650 is coaxial with a corresponding module gap 608 e.g., as schematically shown in FIGS. 6B and 7B-7E. For example, FIG. 7E illustrates battery module 100 comprising one battery cell 150 (top right), which releases gases into module gap 608. In some examples, battery cell 150 is separated from module gap 608 by module cover 170, which can be specially configured to allow any gases to escape from the module enclosure (formed in part by module cover 170) into module gap 608. Various examples of module cover 170 are described above with reference to the first cover 171 and the second cover 172. For example, the first cover 171 of one module may face and form a module gap 608 with the second cover 172 of the adjacent module. As noted above, an insulation structure 609 may be positioned in module gap 608, e.g., between the module covers 170 as shown in FIG. 7E. For example, a mica sheet (e.g., phyllosilicate) can be used as the insulation structure 609.

Referring to FIGS. 6B and 7B, in some examples, each battery module 100 is positioned between two module gaps 608. Specifically, each battery module 100 may have two sets of battery cells 150, e.g., positioned on different sides of the thermal plate as described above. Each set of battery cells 150 is protected by a corresponding module cover (e.g., first cover 171 and second cover 172). These module covers allow gases to escape from battery cells 150 and corresponding battery modules 100 into enclosed pack cavity 605. As such, module gap 608 can be positioned between two module covers (e.g., first cover 171 of one battery module 100 and second cover 172 of the adjacent battery module 100). Furthermore, each module cover can face module gap 608.

Referring to FIG. 7D, in some examples, pressure-relief valves 650 comprises a first subset of pressure-relief valves 651 and a second subset of pressure-relief valves 652. The wall of the first battery-pack portion 610 comprises a first sidewall 611 and a second sidewall 612, opposite the first sidewall 611. The first subset of pressure-relief valves 651 is positioned in and protruding through the first sidewall 611. The second subset of pressure-relief valves 652 is positioned in and protruding through the second sidewall 612. Positioning the pressure-relief valves on both sides reduces the travel of any gases released into the module gaps 608 and provides an additional escape outlet as well as backup. In other words, each module gap 608 is serviced by two pressure-relief valves 650 (one valve in the first subset of pressure-relief valves 651 and another valve in the second subset of pressure-relief valves 652). In some examples, each of the first subset of pressure-relief valves 651 and the second subset of pressure-relief valves 652 consists of five pressure-relief valves. In the same or other examples, battery pack 600 has only 4 battery modules 100.

### Examples of Liquid Cooling in Battery Packs

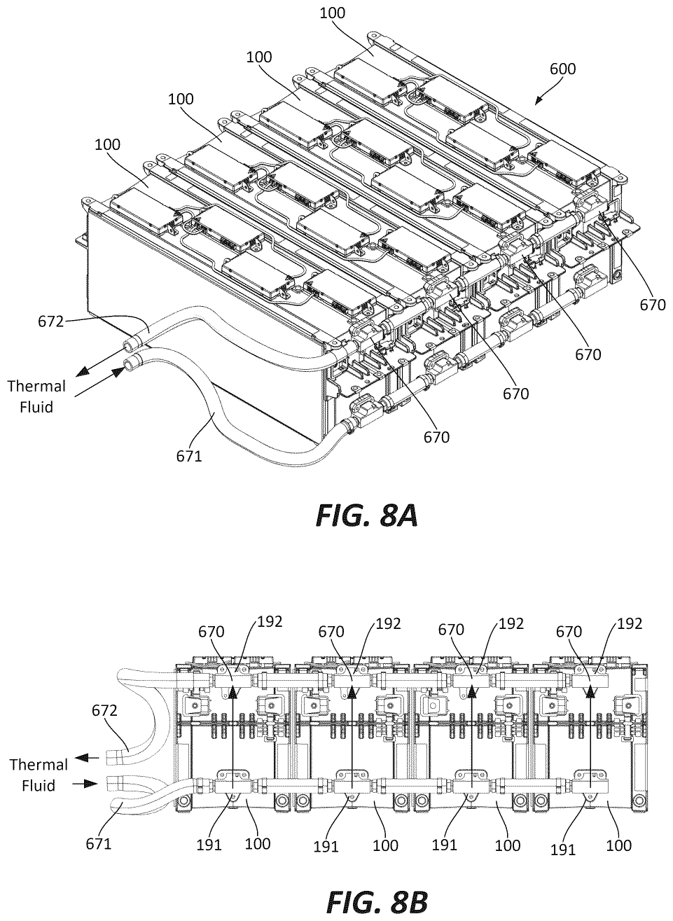

Referring to FIGS. 8A and 8B, in some examples, the battery module 100 of a battery pack 600 are liquid cooled. As described above, battery pack 600 comprises pack inlet tube 671 and pack outlet tube 672 used to flow a thermal fluid within battery pack 600 or, more specifically, to deliver this thermal fluid to each battery module 100. Each battery module 100 is equipped with inlet port 191 and outlet port 192, which are fluidically coupled with a thermal plate positioned between the two sets of battery cells. The design of the thermal plate and the internal liquid routing is described above.

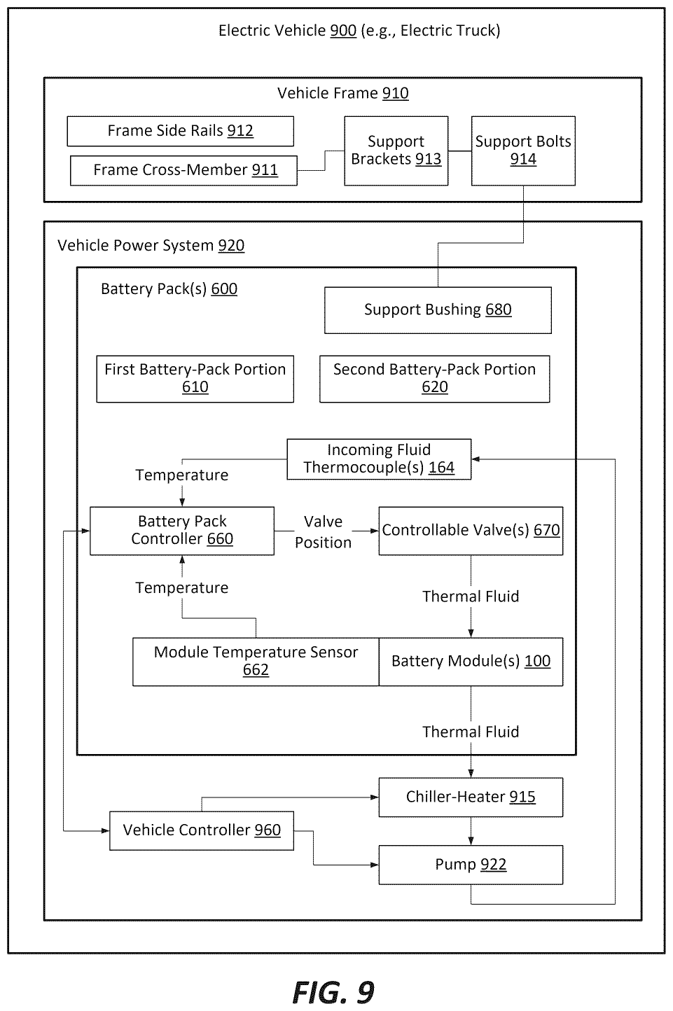

Pack inlet tube 671 is fluidically coupled to inlet port 191 of each battery module 100, while pack outlet tube 672 is fluidically coupled to outlet port 192 of each battery module 100. Battery pack 600 can also comprise a set of controllable valves 670 such that each valve 670 provides a selective fluid pathway between pack inlet tube 671 and inlet port 191 and/or between pack outlet tube 672 and outlet port 192. FIG. 4B illustrates controllable valves 670 being positioned at and controlling the flow through each outlet port 192. However, an example wherein controllable valves 670 are positioned at and control the flow through inlet port 191 is also within the scope. As such, the flow rate of the thermal fluid through each battery module 100 can be independently controlled. The operation of the controllable valves 670 is described below with reference to FIG. 9, e.g., using temperature feedback from each battery module 100.

In some examples, each controllable valve 670 can be replaced with a constant-flow restrictor. Each constant-flow restrictor can be selected such that the volumetric flow rate through each battery module 100 is the same regardless of the module position. For example, a battery module positioned the furthest from the beginning of the pack inlet tube 671 and the pack outlet tube 672 may have the least restrictive constant-flow restrictor, i.e., to compensate for pressure losses in t the pack inlet tube 671 and the pack outlet tube 672.

### Examples of Electric Vehicles and Vehicle Power Systems

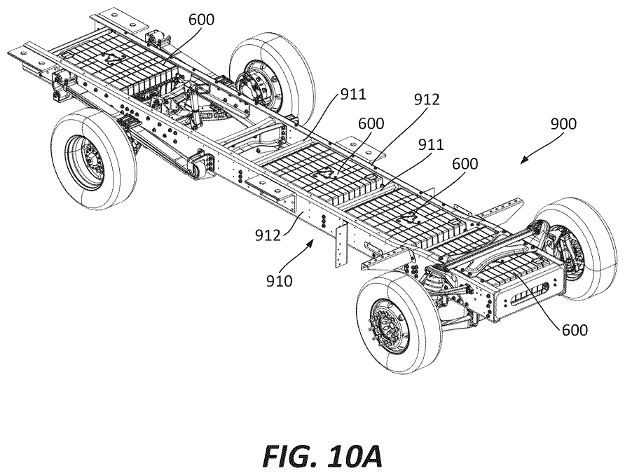

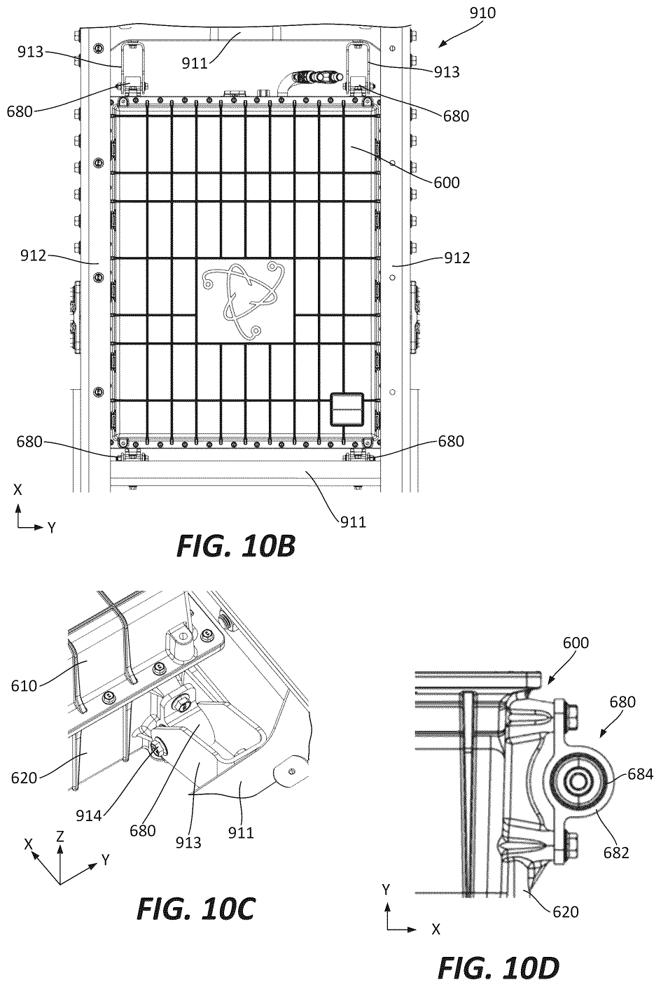

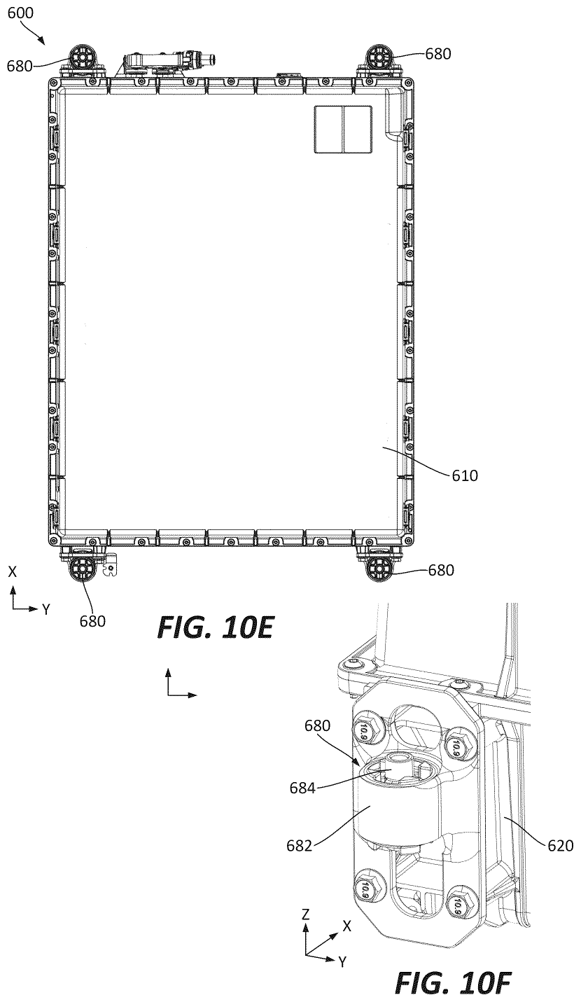

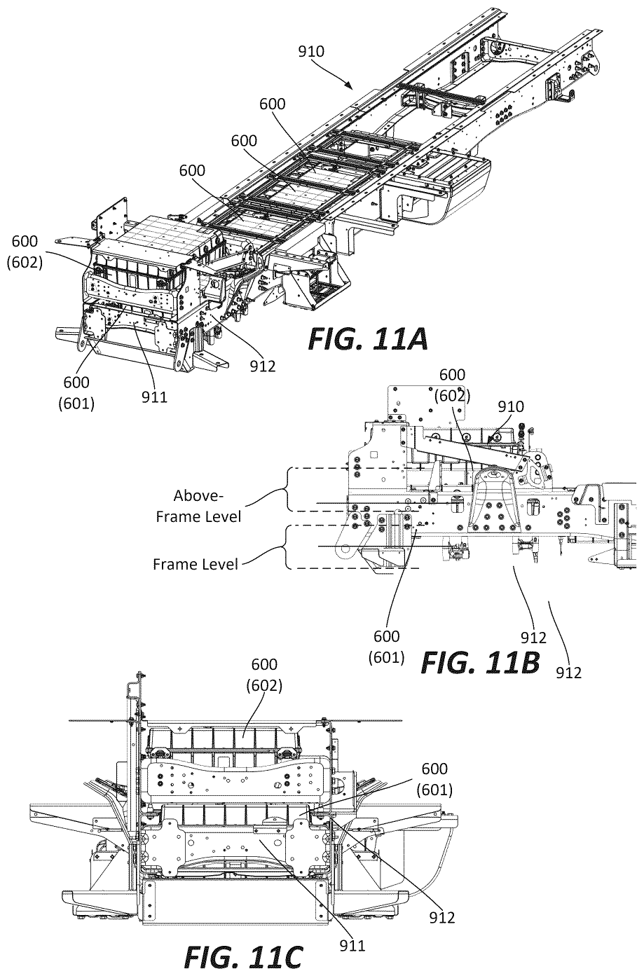

FIG. 9 is a block diagram of an electric vehicle 900 comprising a vehicle power system 920, in accordance with some examples. Specifically, the electric vehicle 900 comprises a vehicle frame 910, which may support various components of the vehicle power system 920, such as battery packs 600. Vehicle frame 910 can comprise frame side rails 912 and frame cross-members 911 that interconnect frame side rails 912. Vehicle frame 910 can also comprise support brackets 913 that utilize support bolts 914 for attaching the battery packs 600 or, more specifically, for attaching the support bushings 680 of the battery packs 600. Additional details of the vehicle frame 910 and of various attachment options are described below with reference to FIG. 10A-11C.

Referring to FIG. 9, in some examples, battery pack 600, which is a part of the vehicle power system 920, further comprises module temperature sensors 662 (e.g., thermocouples) configured to measure the temperature at one or more locations in each battery module 100. The locations can be specifically selected based on the operating regime of each battery module 100 and/or that of the battery pack 600. For example, certain battery cells 150 in the battery module 100 can be subjected to higher currents. In these examples, the module temperature sensor 662 can be positioned around these cells.

In some examples, battery pack 600 further comprises one or more temperature sensors for measuring the temperature of the thermal fluid in various locations within the battery pack 600. For example, one or more temperature sensors can be positioned at the inlet port 191 and outlet port 192 of each module, e.g., to determine the heat output of each module and potentially detect and prevent various undesirable operating conditions associated with each battery module 100.

In some examples, the output of various temperature sensors can be received at a battery pack controller 660, which in some cases may be also referred to as a battery management system (BMS). In some examples, the battery pack controller 660 is also communicatively coupled to a vehicle controller 960. The battery pack controller 660 and/or the vehicle controller 960 can provide operational instructions to controllable valves 670 (if such are used). For example, each controllable valve 670 can be made more open or closed (or completely opened or closed) based on the temperature reading from the module temperature sensor 662. Specifically, battery pack controller 660 can be configured to (1) receive the temperature of the thermal fluid entering each battery module 100, the temperature of the thermal fluid exiting each battery module 100, and the position of each controllable valve 670, and to (2) calculate the total heat transferred in each battery module 100.

In some examples, the electric vehicle 900 also comprises a chiller-heater 915 for changing the temperature of the thermal fluid outside of the battery packs 600. For example, a chiller-heater 915 can comprise a radiator for releasing heat to the environment, an air conditioning/heat pump for cooling the thermal fluid below the temperature of the environment, a heater for heating the thermal fluid, and the like. In some examples, the electric vehicle 900 also comprises a pump 922 for pumping the thermal fluid between the chiller-heater 915 and the battery packs 600.

Examples of Integrating Battery Packs into Electric Trucks

Referring to FIGS. 10A-10F and 11A-11C, in some examples, battery packs 600 are integrated into electric vehicle 900 comprising a vehicle frame 910. As noted above, the vehicle frame 910 can comprise two side rails 912 and set of cross-members 911, each extending perpendicular to and interconnecting two side rails 912. Electric vehicle 900 also comprises a set of battery packs 600, enclosed within and attached to vehicle frame 910. As such, the vehicle frame 910 not only supports but also protects the battery packs 600 (e.g., during the collision of the electric vehicle 900). Furthermore, the vehicle frame 910 can be reinforced by the battery packs 600 (e.g., the battery packs 600 are operable as structural components of the frame 910)

Various examples of battery packs 600 are described above. In some examples, each battery pack 600 comprises first battery-pack portion 610, second battery-pack portion 620, attached to first battery-pack portion 610 and forming enclosed pack cavity 605 with first battery-pack portion 610, and set of battery modules 100 positioned within enclosed pack cavity 605.

Referring to FIGS. 10B-10D, in some examples, the battery packs 600 or, more specifically, the second battery-pack portion 620 comprises support bushings 680 for attaching to the vehicle frame 910. Each support bushing 680 can be positioned adjacent to one corner of the second battery-pack portion 620. Referring to FIG. 10D, in some examples, support bushing 680 comprises (a) rigid bushing enclosure 682 bolted to the wall of second battery-pack portion 620, and (d) elastomeric bushing 684 supported and surrounded by rigid bushing enclosure 682. Referring to FIG. 10C, in some examples, support bushing 680 is pivotably attached to support bracket 913 by a support bolt 914 that protrudes through support bushing 680. In this example, the support bolt 914 extends parallel to the cross-members 911 and parallel to the frame plane (the X-Y plane). FIGS. 10E and 10F illustrate another example of the support bushing 680, which is configured to receive a support bolt 914 (not shown) extending perpendicular to the cross-members 911 and perpendicular to the frame plane (the X-Y plane). This example may simplify the process of mounting of battery packs 600 on the frame and may also provide more damping (using the elastomeric bushing 684) in the direction perpendicular to the frame plane (the X-Y plane).

FIG. 11A is a schematic perspective view of frame 910 and a set of battery packs 600, with two packs stacked in the front portion of frame 910, in accordance with some examples. FIG. 11B is a schematic side view of frame 90 and the two stacked battery packs of FIG. 11A, while FIG. 11C is a corresponding front view. Specifically, the first battery pack 601 is positioned within frame 910, e.g., between the side rails 912. The second battery pack 602 is positioned above frame 910 and is connected to the frame by a pack-supporting structure. This pack configuration is particularly beneficial for electric trucks, which tend to have uneven weight distribution when loaded.

### Examples of Thermal Sensor Modules for Battery Modules

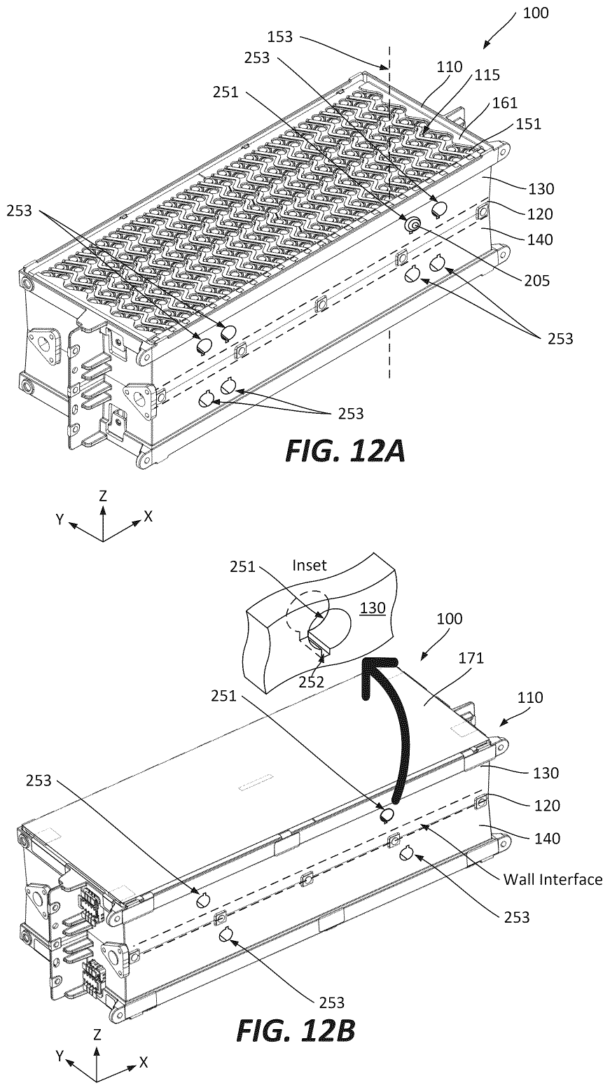

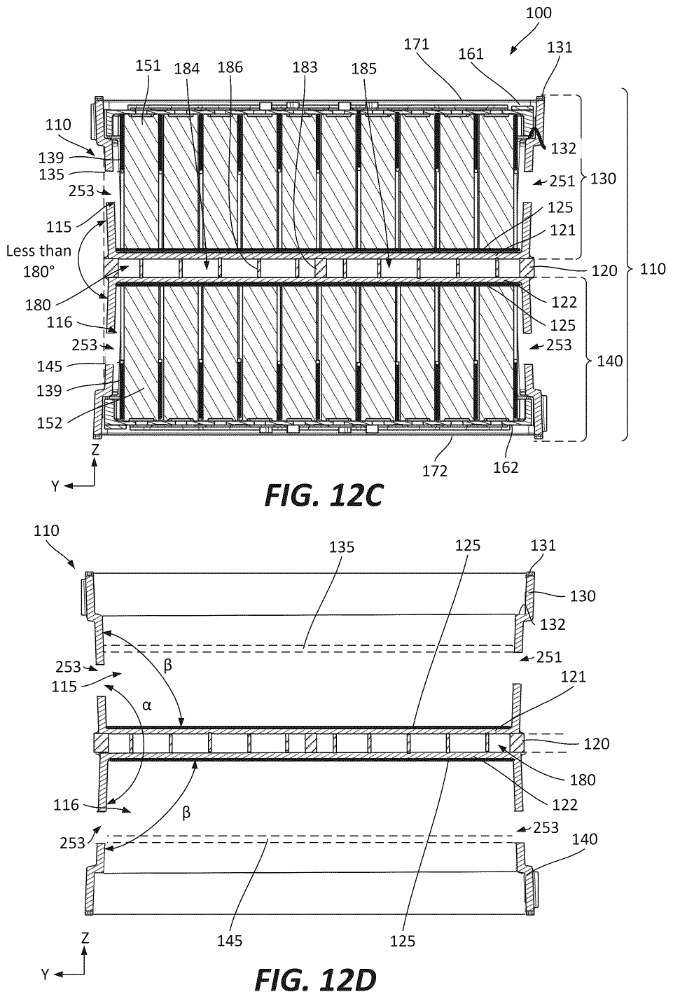

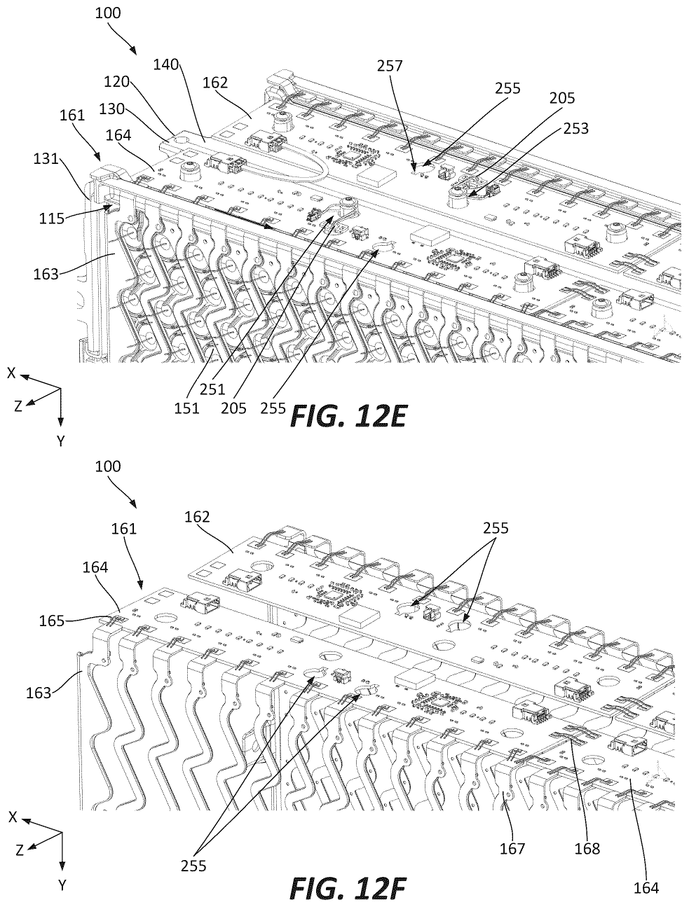

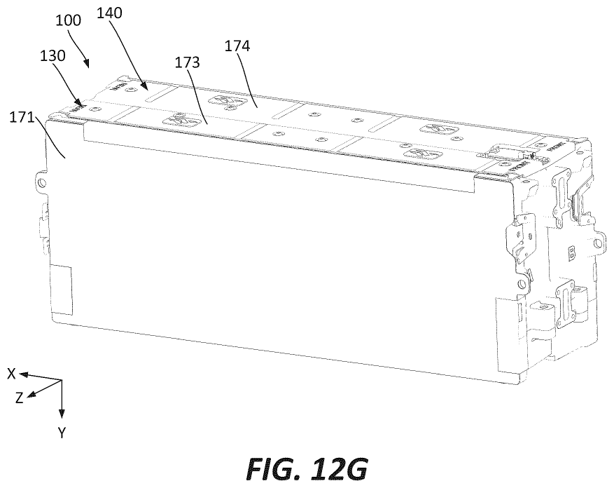

FIG. 12A is a schematic perspective view of a battery module 100 comprising an enclosure 110, a first set of battery cells 151, and a thermal sensor module 205 in accordance with some examples. The enclosure 110 comprises a first thermal wall 121, a second thermal wall 122, and a first set of side walls 130. The first set of side walls 130 and the first thermal wall 121 define a first enclosure portion 115. The first set of side walls 130 comprises a thermal sensor module opening 251. Also shown in FIG. 12A is a battery axis 153. Examples of the first set of side walls 130, first thermal wall 121, second thermal wall 122, and first enclosure portion 115, and the relationships between these components, are described in detail above.

As shown in FIG. 12A, the battery module 100 further comprises a first set of battery cells 151. The first set of battery cells 151 is positioned within the first enclosure portion 115, surrounded by the first set of side walls 130. The first set of battery cells 151 is thermally coupled with the first thermal wall 121. As shown in FIGS. 12A and 12C, the first set of battery cells 151 and/or second set of battery cells 152 can include cylindrical battery cells (e.g., 18650 cells, 21700 cells, 30700 cells, 4680 cells). However, other types of battery cells are within the scope.

FIGS. 12C and 12D are schematic cross-sectional views of the battery module 100, in accordance with some examples. In FIG. 12C, the first set of battery cells 151 is positioned within the first enclosure portion 115 of the battery module 100. In FIG. 12D, the battery module 100 is shown without the first set of battery cells 151. The first thermal wall 121 and second thermal wall 122 are shown in FIGS. 12C and 12D. A thermal portion 120 is defined, at least in part, by the first thermal wall 121 and the second thermal wall 122 collectively forming a thermal cavity 180 therebetween.

In some examples, as shown in FIGS. 12C and 12D, the thermal sensor module opening 251 extends through the first set of side walls 130. In other words, the thermal sensor module opening 251 is an opening that extends from outside of the enclosure 110 to the first enclosure portion 115. In some examples, as shown in FIGS. 12C and 12D, the second set of side walls 140 comprises an additional thermal sensor module opening 253. In some other examples, the first set of side walls 130 comprises both a thermal sensor module opening 251 and an additional thermal sensor module opening 253. In further examples, the enclosure 110 may comprise an additional thermal sensor module opening 253 or more than one additional thermal sensor module openings 253. In some of these examples, the first set of side walls 130 comprises an additional thermal sensor module opening 253. In the same or other of these examples, the second set of side walls 140 comprises an additional thermal sensor module opening 253.

FIG. 12B is a schematic perspective view of the battery module 100 in which the enclosure 110 comprises a first cover 171, in accordance with some examples. As described above, the first cover 171 can seal the first enclosure portion 115.

An isometric view of a portion of the first set of side walls 130 and the thermal sensor module opening 251 is shown in an inset in FIG. 12B. In some examples, the thermal sensor module opening 251 has a circular or elliptical cross-section in a plane parallel with a side of the first set of side walls 130. In some further examples, the thermal sensor module opening 251 also comprises a keyway 252. The keyway 252 may have a rectangular cross-section in the plane parallel with the side of the first set of side walls 130. The keyway 252, when present, extends from outside of the enclosure 110 to at least part way between the outside of the enclosure 110 and the first enclosure portion 115.

FIGS. 12E and 12F are schematic perspective views of the battery module 100, in accordance with some examples. FIG. 12F is an example of the two interconnecting assemblies in FIG. 1E without the module enclosure, thermal sensor modules, and battery cells. As shown in FIG. 12E, in some examples, the battery module 100 comprises at least one printed circuit board. In some examples, as shown in FIG. 12E, the at least one printed circuit board is positioned at least partially overlapping with the first set of side walls 130. In some examples, the at least one circuit board physically contacts the first set of side walls 130. In some examples, the printed circuit boards 164 is affixed to the first set of side walls 130 by connectors. The connectors may comprise bolts, screws, curable adhesives, pressure-sensitive adhesives, and the like. In some examples, the printed circuit boards 164 comprise at least one thermal-sensor-module-board opening 255 that extends through a thickness of the printed circuit boards 164. As shown in FIG. 12E and FIG. 12F, in some examples, the at least one thermal-sensor-module-board opening 255 comprises a PCB keyway 257. At least one thermal-sensor-module-board opening 255 and the PCB keyway 257 will be described in more detail below in reference to the thermal sensor module 205.

FIG. 12G is a schematic perspective view of a battery module 100 comprising a side cover 173 and an additional side cover 174, in accordance with some examples. In some examples, the side cover 173 at least partially overlaps both the first set of side walls 130 and the second set of side walls 140. In some other examples, as shown in FIG. 12G, the side cover 173 at least partially overlaps the first set of side walls 130 and the additional side cover 174 at least partially overlaps the second set of side walls 140. The side cover 173 and additional side cover 174 will be described in more detail below in reference to the thermal sensor module 205. In some examples, the side cover 173 at least partially overlaps the printed circuit boards 164. In some examples, as shown in FIG. 12G, the side cover 173 and the additional side cover 174 together completely overlap the printed circuit boards 164. The side cover 173 and the additional side cover 174 may comprise a plastic, a glass-reinforced epoxy, or a metal. The side cover 173 and the additional side cover 174 may be formed by fabrication methods including, but not limited to, machining, forging, injection molding, and additive manufacturing.

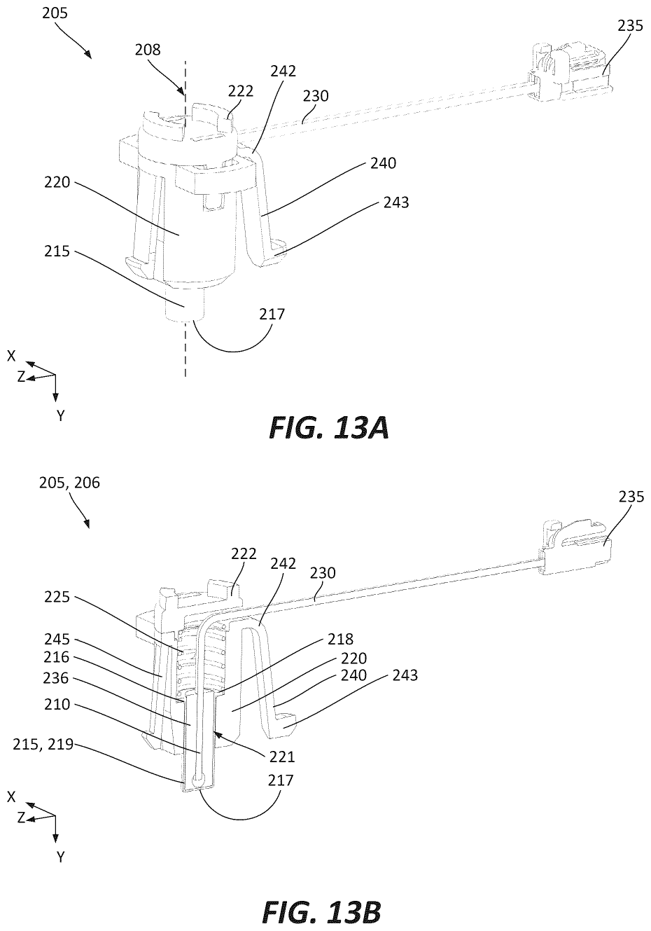

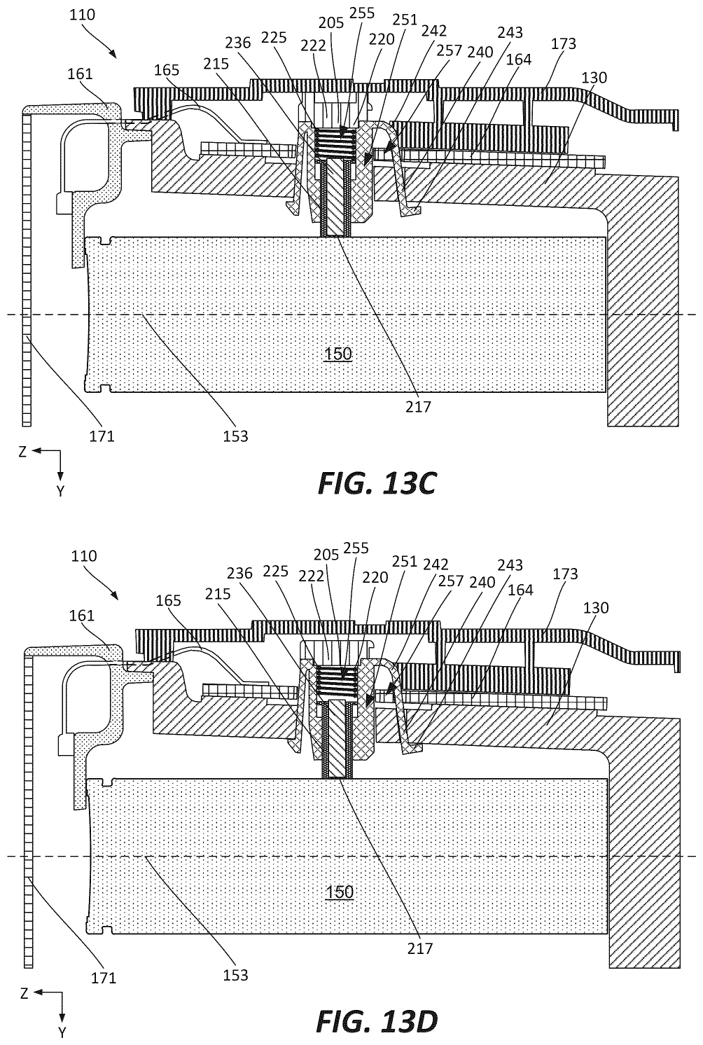

FIG. 13A is a perspective view of a thermal sensor module 205, in accordance with some examples. FIG. 13B is a cross-sectional perspective view of the thermal sensor module 205, in accordance with some examples. The thermal sensor module 205 comprises a thermal module axis 208, a thermal sensor module housing 220, a thermal sleeve 215, and a temperature sensor 210. At least a portion of the thermal sleeve 215 is positioned within the thermal sensor module housing 220. The temperature sensor 210 is positioned within and thermally coupled with the thermal sleeve 215. In some examples, the temperature sensor 210 is a negative temperature coefficient thermistor. The electrical resistance of a negative temperature coefficient thermistor decreases as its temperature increases. In some examples, the temperature sensor 210 is a bead-type thermistor. In some other examples, the temperature sensor 210 is a thermocouple. In some examples, the temperature sensor 210 has an operation temperature range of between −55 and +300° C., between −75 and 150° C., between −100 and 200° C., or even between −200 and 300° C. The temperature sensor 210 is positioned within and is thermally coupled with the thermal sleeve 215. The thermal sleeve 215 physically contacts and is thermally coupled with one of the first set of battery cells 151. The thermal sleeve 215 may comprise a metal, for example, aluminum, an aluminum alloy, copper, a copper alloy, carbon steel, stainless steel, spring steel, and the like. The thermal sensor module housing 220 may comprise a plastic material, for example, polyethylene, polypropylene, nylon, and the like.

In some examples, the thermal sensor module 205 further comprises a sensor wire harness 230 and a thermal sensor connector 235. As shown in FIGS. 13A-B, the thermal sensor connector 235 is physically coupled with the sensor wire harness 230. As shown in FIG. 13B, the sensor wire harness 230 is physically coupled with the temperature sensor 210. The sensor wire harness 230 is electrically coupled with the temperature sensor 210 and the thermal sensor connector 235 is electrically coupled with the sensor wire harness 230. Specifically, the sensor wire harness 230 may comprise two electrically conductive wires separated from one another by an insulating material. Each one of the electrically conductive wires is electrically connected to a separate electrical lead of the temperature sensor 210. The thermal sensor connector 235 may comprise two connector conductors, each of which is electrically coupled with one of the electrically conductive wires. The thermal sensor connector 235 comprises a non-conductive material that electrically separates the two connector conductors. In some examples, the thermal sensor module 205 protrudes through at least one of the printed circuit boards 164, and the thermal sensor connector 235 is mechanically and electrically coupled with at least one of the printed circuit boards 164. In this way, electrical connections may be formed between the temperature sensor 210 and the printed circuit boards 164.

In some examples, the thermal sensor module housing 220 comprises a thermal sensor module housing opening 221, as shown in FIG. 13B. In these examples, the thermal sleeve 215 is positioned within the thermal sensor module housing opening 221. The thermal sleeve 215 is slidably coupled with the thermal sensor module housing 220.

As shown in FIG. 13B, in some examples, the thermal filler 236 physically contacts the thermal sleeve 215 and the temperature sensor 210. In some examples, the thermal filler 236 is thermally conductive and thermally couples the temperature sensor 210 with the thermal sleeve 215. The thermal filler 236 may comprise a thermally conductive material such as a metal, an epoxy, an adhesive, or a silicone. When the thermal filler 236 comprises an epoxy, an adhesive, or a silicone, the thermal filler 236 may comprise a thermally-conductive filler, such as aluminum nitride, silicon carbide, graphite, silver, or copper. In some examples, the thermal filler 236 has a thermal conductivity of greater than 0.5 W/mK, greater than 1 W/mK, greater than 3 W/mK, greater than 50 W/mK, or even greater than 100 W/mK. A thermal filler 236 with a higher thermal conductivity permits a faster response of the temperature reported by the temperature sensor 210 to changes in the temperature of the battery cells 150 the thermal sleeve 215 is thermally coupled with.

In some examples, as shown in FIG. 13B, the proximal end 216 comprises a retention flange 218. The retention flange 218 has a diameter in a plane orthogonal to the thermal module axis 208 that is larger than the diameter of the thermal sensor module housing opening 221. In this way, while the thermal sleeve 215 may transmit in directions parallel with the thermal module axis 208, the travel of the thermal sleeve 215 is limited by physical contact of the retention flange 218 with an inside surface of the thermal sensor module housing 220. This prevents the thermal sleeve 215 from uncoupling from the thermal sensor module housing 220 by sliding towards, or in the direction of, the distal end 217 past the thermal sensor module housing opening 221. In addition, the retention flange 218 may physically contact the thermal sensor module spring 225. In this way, the retention flange 218 may provide a physical interface for transfer of mechanical force from the thermal sensor module spring 225 to the thermal sleeve 215.

In some examples, the thermal sensor module 205 further comprises a thermal sensor module spring 225 positioned within the thermal sensor module housing 220. The thermal sensor module spring 225 is configured to urge the thermal sleeve 215 against the one of the first set of battery cells 151. In some examples, the thermal sensor module spring 225 is configured to urge the thermal sleeve 215 against two cells of the first set of battery cells 151. The thermal sensor module spring 225 causes the thermal sleeve 215 to maintain contact with one or more battery cells as the battery cells increase and decrease in size during charging and discharging.

In some examples, the thermal sleeve 215 comprises a proximal end 216 and a distal end 217, as shown in FIG. 13B. The thermal sleeve 215 protrudes outwardly from the thermal sensor module housing 220. Specifically, the distal end 217 is positioned outside of the thermal sensor module housing 220. The proximal end 216 is opposite the distal end 217.

In some examples, the thermal sensor module 205 further comprises a thermal sensor module cap 222. An example of the thermal sensor module cap 222 is shown in FIGS. 13A-B. The thermal sensor module cap 222 may physically contact the thermal sensor module housing 220 and may be positioned at an opposite end of the thermal sensor module housing 220 from the thermal sleeve 215. The thermal sensor module cap 222 may comprise the same material as the thermal sensor module housing 220 or another of the materials described in reference to the thermal sensor module housing 220. The thermal sensor module cap 222, when present, may be reversibly affixed to the thermal sensor module housing 220 or permanently affixed to the thermal sensor module housing 220. The thermal sensor module cap 222, when present, may physically contact the thermal sensor module spring 225. Specifically, the thermal sensor module spring 225 may physically contact and apply force to both the thermal sensor module cap 222 and the thermal sleeve 215, urging the thermal sleeve 215 away from the thermal sensor module cap 222. In some examples, the thermal sensor module cap 222 is monolithic with the thermal sensor module housing 220. As shown in FIG. 13B, the thermal sensor module cap 222 may comprise an opening through which the sensor wire harness 230 may pass.

In some examples, when the side cover 173 is installed on the battery module 100, the side cover 173 physically contacts the thermal sensor module cap 222, and the thermal sensor module spring 225 physically contacts the thermal sensor module cap 222. In some of these examples, a force applied to the thermal sensor module cap 222 by the side cover 173 translates the thermal sensor module housing 220 along the thermal module axis 208 relative to the first set of side walls 130, towards the first set of battery cells 151, countering a force applied by the thermal sensor module spring 225 between the thermal sensor module cap 222 and the thermal sleeve 215. In these examples, the retention tab 240 may physically contact the first set of side walls 130, but the retention tab protrusion 243 does not physically contact the first set of side walls 130 after the side cover 173 is installed on the battery module 100. In some examples, the side cover 173 physically contacts the first set of side walls 130 and at least partially overlaps at least one of the thermal sensor module 205, the thermal sensor module opening 251, and the at least one thermal-sensor-module-board opening 255. In some further examples, the additional side cover 174 physically contacts the second set of side walls 140 and at least partially overlaps the additional thermal sensor module 206.

In some examples, the thermal sensor module housing 220 comprises a retention tab 240. The retention tab 240 may be monolithic with the thermal sensor module housing 220. The retention tab 240 may be affixed to the thermal sensor module housing 220 and comprise a different material than the thermal sensor module housing 220. The retention tab 240 may be positioned relative to the thermal sensor module housing 220 such that the thermal sensor module 205 may be inserted in the thermal sensor module opening 251 when the thermal sensor module 205 is rotated about the thermal module axis 208 such that the retention tab 240 is aligned with the keyway 252. The retention tab 240 may comprise a retention tab shoulder 242 and a retention tab protrusion 243. The retention tab 240 may connect to the thermal sensor module housing 220 via the retention tab shoulder 242 and the retention tab 240 may be configured to flex at the retention tab shoulder 242 when force is applied to the retention tab 240 in a direction orthogonal to the thermal module axis 208. The retention tab protrusion 243 may extend from the retention tab 240. When the thermal sensor module housing 220 is positioned in the thermal sensor module opening 251, the retention tab 240 may apply a force to a portion of the first set of side walls 130, thereby affixing the thermal sensor module housing 220 relative to the first set of side walls 130. The application of a force to a portion of the first set of side walls 130 by the retention tab 240 may provide installation assurance. In other words, when the thermal sensor module 205 is inserted in the thermal sensor module opening 251 and the retention tab 240 applies a force to a portion of the first set of side walls 130, the force may ensure the thermal sensor module 205 remains inserted in the thermal sensor module opening 251 during later steps of assembly of the battery module 100. For example, insertion of the thermal sensor module 205 into the thermal sensor module opening 251 may require pressing a portion of the retention tab 240 towards the thermal sensor module housing 220 in order for the retention tab protrusion 243 to pass the keyway 252 from the outside of the battery module 100 to the first enclosure portion 115. The retention tab 240 may be configured such that releasing the retention tab 240 when the thermal sensor module 205 is inserted into the thermal sensor module opening 251 allows the retention tab 240 to extend away from the thermal sensor module housing 220.

The retention of the thermal sensor module 205 within the thermal sensor module opening 251 by the retention tab 240 during installation provides several benefits over affixing a temperature sensor 210 to one of the battery cells 150 with thermally-conductive adhesive. For example, installation of the thermal sensor module 205 retained by a retention tab 240 is simpler to automate in manufacturing than application of adhesives, for example, in the form of liquid adhesive or a pressure sensitive adhesive. Also, installation of the thermal sensor module 205 comprising a retention tab 240 in the thermal sensor module opening 251 is more reversible than affixing a temperature sensor 210 to a battery cell with thermally-conductive adhesive. If the temperature sensor 210 is incorrectly installed or fails, if affixed to one of the battery cells 150 by adhesive, replacement may require replacement of the entire battery module 100. Replacement of the thermal sensor module 205 comprising a retention tab 240 is reversible. In addition, thermal conductivity between the metal outer surface of the battery and the metal thermal sleeve 215 is faster in the case of the thermal sensor module 205 than in the case of a temperature sensor 210 affixed to and separated from the metal outer surface of the battery by an adhesive. Also, a bond from a thermally-conductive adhesive can fail over time of use, especially when exposed to repeated thermal cycling. In addition, the thermal sensor module 205 provides the benefit of comprising a temperature sensor 210 that can be replaced after failure, without replacing the battery cells 150 of the battery module 100. The thermal sensor module 205 can be uninstalled, the temperature sensor 210 can be replaced in the thermal sensor module 205, possibly with the replacement also of the thermal filler 236 and the thermal sleeve 215, and then the thermal sensor module 205 can be re-installed in the battery module 100. This can be especially beneficial in cases of troubleshooting a malfunctioning battery module 100. The thermal sensor module 205 can be uninstalled and tested, repaired, or replaced with a new thermal sensor module 205 without replacing or removing the battery cells 150 from the battery module 100.

As shown in FIGS. 13A-B, in some examples, the thermal sensor module 205 comprises an additional retention tab 245. The additional retention tab 245 may comprise any of the materials described in reference to the retention tab 240. The additional retention tab 245 may comprise the same material as the retention tab 240 or different materials. The additional retention tab 245 may be affixed to the thermal sensor module housing 220 or monolithic with the thermal sensor module housing 220. The additional retention tab 245 may be affixed to the thermal sensor module 205 on a side of the thermal sensor module 205 opposite the retention tab 240 or positioned on the thermal sensor module 205 at a point between the retention tab 240 and a point opposite the retention tab 240. In some examples, the thermal sensor module 205 may comprise two, three, four, or even more than four additional retention tabs 245. The additional retention tab 245 may be configured to flex towards the thermal module axis 208 when a force is applied to the additional retention tab 245 in a direction orthogonal to the thermal module axis 208. In some examples, insertion of the thermal sensor module 205 in the thermal sensor module opening 251 requires flexion of the additional retention tab 245 such that the additional retention tab 245 passes the thermal sensor module opening 251. Release of the force from the additional retention tab 245 after insertion of the thermal sensor module 205 in the thermal sensor module opening 251 may allow flexion of the additional retention tab 245 away from the thermal sensor module housing 220 and towards the first set of side walls 130. When the additional retention tab 245 is present, forces applied by the retention tab 240 and the additional retention tab 245 to the first set of side walls 130 may position the thermal sensor module 205 within the thermal sensor module opening 251 or prevent the de-insertion of the thermal sensor module 205 from the thermal sensor module opening 251.

FIGS. 13C-D are schematic, cross-sectional views of the battery module 100 comprising battery cells 150, the thermal sensor module 205, and with the side cover 173 installed, in accordance with some examples. In some examples, the retention tab protrusion 243 physically contacts the first set of side walls 130 when the thermal sensor module 205 is installed in the thermal sensor module opening 251 and the side cover 173 is not installed on the battery module 100. In these examples, the retention tab protrusion 243 does not physically contact the first set of side walls 130 when the thermal sensor module 205 is installed in the thermal sensor module opening 251 and the side cover 173 is installed on the battery module 100, as shown in FIG. 13C. In these examples, the retention tab 240 may be pressed towards the thermal sleeve 215 during installation of the thermal sensor module 205 in the first set of side walls 130 and then pressure may be released. Upon release of the pressure, the retention tab 240 physically contacts the first set of side walls 130, thereby providing retention of the thermal sensor module 205 in the thermal sensor module opening 251. Then, when the side cover 173 is installed on the battery module 100, the side cover 173 applies pressure to the thermal sensor module 205 at the thermal sensor module cap 222 and towards the battery cells 150. In these examples, the retention tab 240 provides retention of the thermal sensor module 205 in the thermal sensor module opening 251 after installation and until the side cover 173 is installed on the battery module 100 in a later manufacturing step. This may simplify manufacturing of the battery module 100 and improve assembly quality of the battery module 100, especially when more than one thermal sensor module 205 is installed in the battery module 100 prior to installation of the side cover 173, by assuring each thermal sensor module 205 installed in the first set of side walls 130 remains installed through further manufacturing steps. Installation of the side cover 173, in these examples, provides assurance that the thermal sensor module 205 is installed in the thermal sensor module opening 251. As shown in FIG. 2C, the retention tab protrusion 243 has a surface facing away from the battery cells 150 and the first set of side walls 130 has a surface facing the battery cells 150. In these examples, after installation of the side cover 173, the surface of the retention tab protrusion 243 facing away from the battery cells 150 does not physically contact the surface of the first set of side walls 130 facing the battery cells 150.

In some other examples, as shown in FIG. 13D, the retention tab protrusion 243 physically contacts the first set of side walls 130 when the thermal sensor module 205 is installed in the thermal sensor module opening 251, regardless of whether the side cover 173 is installed on the battery module 100. In these examples, the first set of side walls 130 applies pressure to the thermal sensor module 205 towards the battery cells 150 via physical contact of the surface of the first set of side walls 130 facing the battery cells 150 with the surface of the retention tab 240 facing away from the battery cells 150, thereby retaining the thermal sensor module 205 within the thermal sensor module opening 251. In some further examples, the side cover 173 physically contacts the thermal sensor module cap 222 when the side cover 173 is installed on the battery module 100. In some other further examples, the side cover 173 does not physically contact the thermal sensor module cap 222 when the side cover 173 is installed on the battery module 100.

Returning to FIG. 12E, in some examples, the printed circuit boards 164 comprise at least one thermal-sensor-module-board opening 255. In some examples, the printed circuit boards 164 comprise two, three, four, or more thermal-sensor-module-board openings 255. Specifically, each printed circuit board may comprise two thermal-sensor-module board openings 255. In some of these examples, one of the at least one thermal-sensor-module-board opening 255 overlaps with one thermal sensor module opening 251 when the printed circuit board is installed on the first set of side walls 130. When another one of the printed circuit boards 164 is installed on the second set of side walls 140, the other of the two thermal-sensor-module-board openings 255 overlaps one thermal sensor module opening 251 in the second set of side walls 140. In other words, the two thermal sensor module opening 251 are offset from one another along an axis orthogonal to the battery axis 153 and parallel with the first set of side walls 130 and the second set of side walls 140. The two thermal sensor module opening 251 are offset such that one thermal sensor module opening 251 is aligned with the battery axis 153 of a battery cell in the first set of battery cells 151 and the other thermal sensor module opening 251 is aligned with the battery axis 153 of a cell in the second set of battery cells 152. The battery axis 153 of a battery cell in the first set of battery cells 151 and the battery axis 153 of a cell in the second set of battery cells 152 may be offset in a direction orthogonal to the battery axis 153 if the batteries are oriented in opposite directions along the battery axis 153 and the battery cells of the first set of battery cells 151 and battery cells of the second set of battery cells 152 are packed in the same positions within the sets of battery cells. In other words, if the first set of battery cells 151 and the second set of battery cells 152 are manufactured in the same way, and the first set of battery cells 151 and the second set of battery cells 152 are then installed in the battery module 100 facing opposite directions along the battery axis 153, the battery cells in the first set of battery cells 151 and the battery cells in the second set of battery cells 152 may not align coaxially along the same battery axis 153. However, two printed circuit boards 164 manufactured according to the same layout, each having two thermal-sensor-module-board openings 255, may provide alignment of the thermal sensor module 205 with a battery cell of the first set of battery cells 151 and alignment of another thermal sensor module 205 with a battery cell of the second set of battery cells 152. In these examples, the printed circuit boards 164 may be oriented 180 degrees relative to one another in a plane parallel with the battery axis 153. This may provide benefits in manufacturing due to one printed circuit boards 164 suitable for multiple installations on one the battery module 100, despite different locations, relative to the installed printed circuit boards 164, of the sensor module opening 251 and the additional thermal sensor module opening 253. In addition, two openings in each printed circuit boards 164 as described above may decrease the need to design, manufacture, and stock two different thermal sensor modules for assembly of the battery module 100. For example, both the thermal sensor module opening 251 and the additional thermal sensor module opening 253 may be positioned such that the same design of the thermal sensor module 205, with the same shape of the distal end 217, may be used to contact battery cells in the first set of battery cells 151 and the second set of battery cells 152.

In some examples, the printed circuit boards 164 comprise one thermal-sensor-module-board opening 255. In these examples, when the battery cells of the first set of battery cells 151 and the battery cells of the second set of battery cells 152 are not positioned co-axially in the battery module 100, thermal sensor modules 205 with differently shaped distal ends 217 may be installed within the same battery module 100. For example, a thermal sensor module 205 with a flat distal end 217 may be installed in a thermal sensor module opening 251 and the thermal sensor module 205 with a slanted distal end 217 may be installed in the additional thermal sensor module opening 253. In this example, the thermal sensor module opening 251 may align with the battery axis 153 of a battery cell in the first set of battery cells 151 and the additional thermal sensor module opening 253 may align with a space between the battery axes of two battery cells of the second set of battery cells 152. The additional thermal sensor module 206 comprises an additional sensor module thermal sleeve 219. The shape of the distal end 217 of the additional sensor module thermal sleeve 219 enables thermal contact of the additional sensor module thermal sleeve 219 with two battery cells of the second set of battery cells 152. For example, the distal end 217 of the additional sensor module thermal sleeve 219 may be partially positioned between and physically contact the surfaces of two cells of the battery cells of the second set of battery cells 152. In these examples, the additional thermal sensor module 206 measures the temperature of two batteries of the second set of battery cells 152.

The PCB keyway 257, when present in at least one thermal-sensor-module-board opening 255, permits passage of the retention tab 240 when the thermal sensor module 205 comprises a retention tab 240, thereby enforcing alignment of the retention tab 240 with the keyway 252 when the thermal sensor module 205 is inserted into the thermal sensor module opening 251. In some examples, the thermal sensor module 205 does not physically contact the printed circuit boards 164 when the thermal sensor module 205 is installed in the thermal sensor module opening 251. In some other examples, the thermal sensor module 205 physically contacts the printed circuit boards 164 when the thermal sensor module 205 is installed in the thermal sensor module opening 251.

### Examples of Thermal Sleeves for Thermal Sensor Modules

The shape of the distal end 217 of the thermal sleeve 215 may have a shape that is flat, curved, or another shape. A distal end 217 that is curved may be curved outward (convex) or curved inward (concave). As will be described below, the shape of the distal end 217 and its position relative to the battery axis 153 affect the contact area of the thermal sleeve 215 with the battery cells 150. The transfer of heat between the battery cells 150 and the thermal sensor module 205 will be slower at contact with a smaller contact area. Slow transfer of heat between the battery cells 150 and the thermal sensor module 205 will result in a slower response time and less accurate temperature readings provided by the thermal sensor module 205.

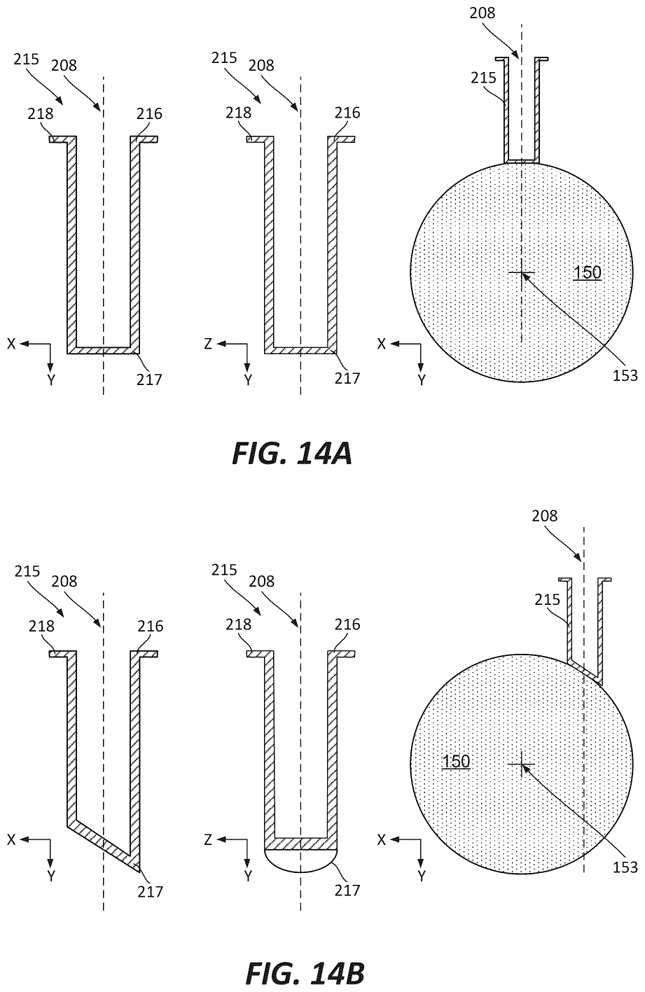

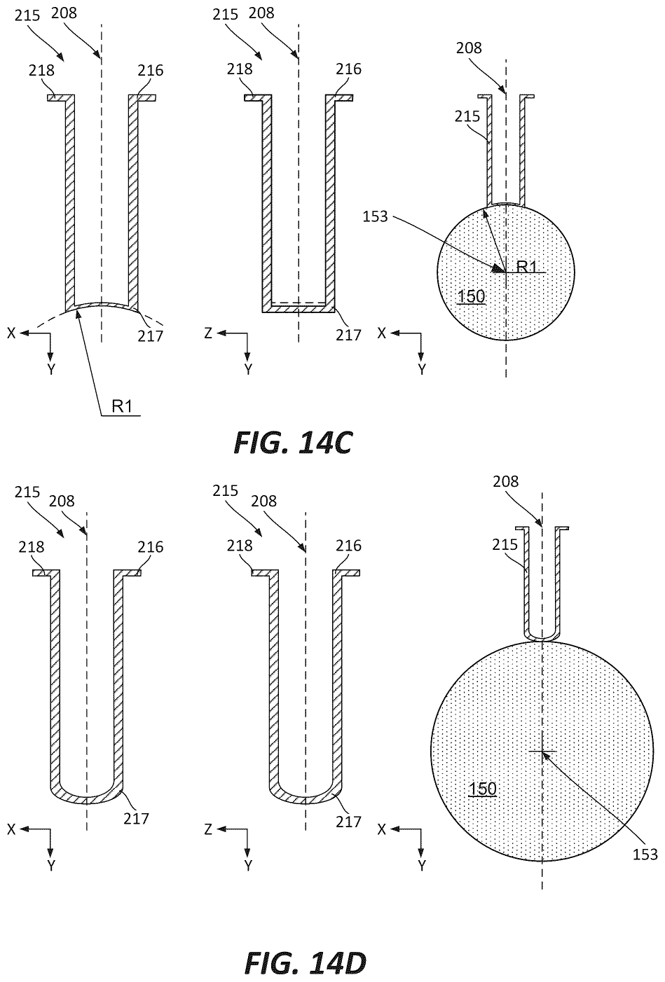

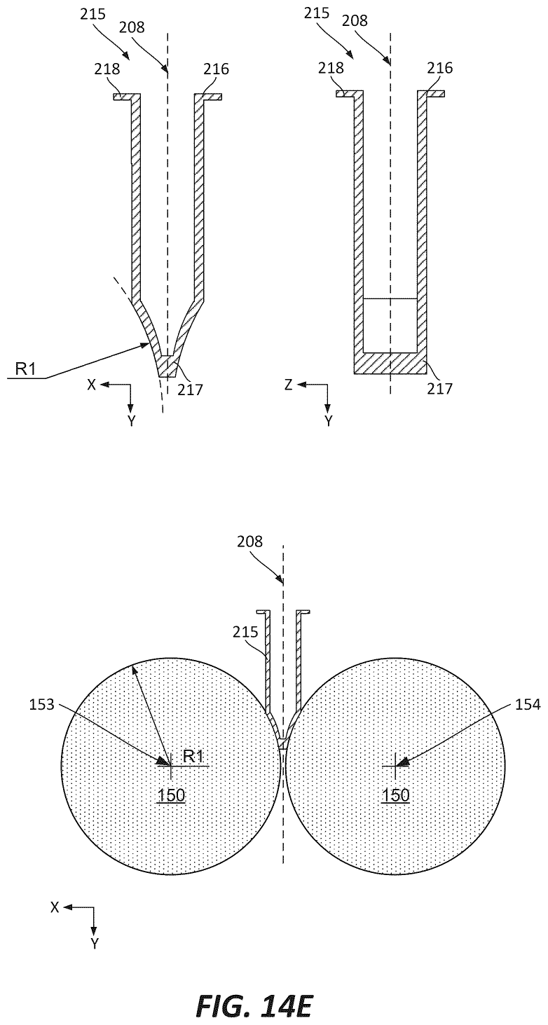

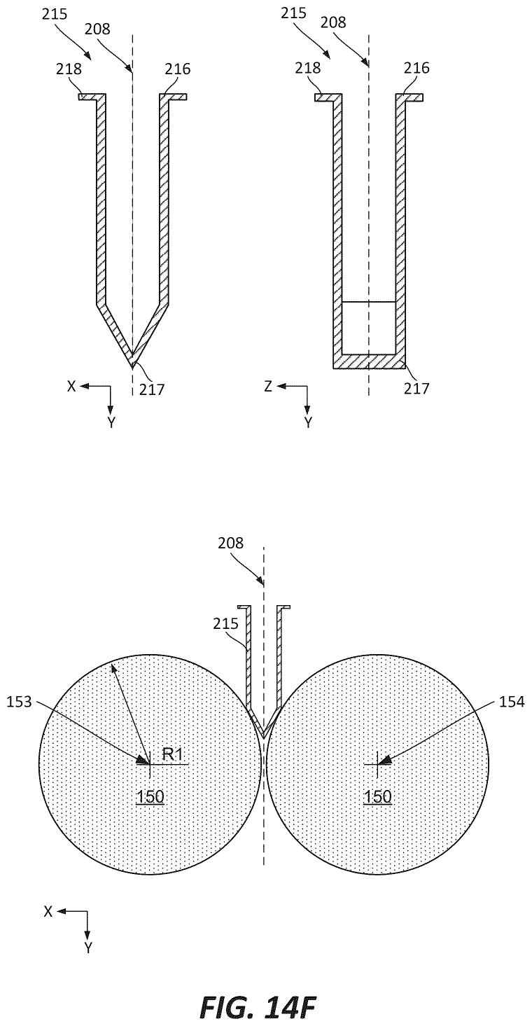

FIGS. 14A-F are cross-sectional side views of thermal sleeves 215 in contact with battery cells, in accordance with some examples. In some examples, as shown in FIG. 14A, the distal end 217 has a flat shape. In FIG. 14A, the distal end 217 comprises a portion parallel with a plane oriented orthogonal to the thermal module axis 208 and parallel with the battery axis 153. In these examples, the contact area between the thermal sleeve 215 and the battery cells 150 is along a line parallel with the battery axis 153. The line may intersect the thermal module axis 208, as shown in FIG. 14A, if the thermal module axis 208 intersects the battery axis 153. In other examples, the thermal module axis 208 does not intersect the battery axis 153 and the contact area does not intersect the thermal module axis 208. The distal end 217 shape of FIG. 14A provides the same contact area regardless of the rotation of the thermal sleeve 215 about the thermal module axis 208 during installation. However, the more displaced the thermal module axis 208 is from the battery axis 153, the smaller the area of contact will be between the thermal sleeve 215 and the battery cells 150. The distal end 217 shape of FIG. 14A provides the same contact area regardless of changes to the radius of the battery about the battery axis 153 during charging and discharging of the battery cells 150.

The portion of the thermal sleeve 215 shown in FIG. 14A extending between the proximal end 216 and the distal end 217 has a cylindrical shape. In other examples, the portion of the thermal sleeve 215 extending between the proximal end 216 and the distal end 217 may be a triangular prism, a rectangular prism, a pentagonal prism, a hexagonal prism, or other prismatic shapes.

In some examples, as shown in FIG. 14B, the distal end 217 has a flat shape and comprises a portion that is not parallel with a plane oriented orthogonal to the thermal module axis 208. In these examples, the contact area between the thermal sleeve 215 and the battery cells 150 may be along a line parallel with the battery axis 153. The line may intersect the thermal module axis 208 and not intersect the battery axis 153, as shown in FIG. 14B. The distal end 217 shape of FIG. 14B provides the same contact area regardless of the location of the thermal module axis 208 relative to the battery axis 153, as long as the distal end 217 contacts the battery cells 150, when the thermal sleeve 215 is rotationally positioned about the thermal module axis 208 as shown in the rightmost of FIG. 14B. This may provide an increase in tolerance to relative positioning between the battery cells 150 and the thermal sensor module 205 during installation. The distal end 217 shape of FIG. 14B provides the same contact area regardless of changes to the radius of the battery about the battery axis 153 during charging and discharging of the battery cells 150. However, if the thermal sleeve 215 rotates about the thermal module axis 208 from this orientation, the contact area will be smaller.

In some examples, as shown in FIG. 14C, the distal end 217 has a curved shape that is concave. In these examples, the portion of the thermal sleeve 215 extending between the proximal end 216 and the distal end 217 is a rectangular prism. In some examples, the radius of curvature of the curved shape is substantially the same radius of curvature of the battery cells 150. In these examples, the distal end 217 will provide a large area of contact between the thermal sleeve 215 and one of the battery cells 150 when the thermal module axis 208 intersects the battery axis 153 and the thermal sleeve 215 is oriented about the thermal module axis 208 as indicated in FIG. 14C. However, The distal end 217 shape of FIG. 14C will provide a smaller area of contact when the thermal module axis 208 does not intersect the battery axis 153 or the thermal sleeve 215 is otherwise oriented about the thermal module axis 208. Also, the distal end 217 shape of FIG. 14C will provide a smaller area of contact when the radius of the battery cell contacted by the thermal sleeve 215 changes during charging and discharging.

In some examples, as shown in FIG. 14D, the distal end 217 has a curved shape that is convex. In these examples, the contact area between the thermal sleeve 215 and the battery cells 150 may intersect the thermal module axis 208 and the thermal module axis 208 intersects the battery axis 153. The contact area may be offset from the thermal module axis 208 when the thermal module axis 208 does not intersect the battery axis 153. The portion of the thermal sleeve 215 extending between the proximal end 216 and the distal end 217 may be a cylinder or a rectangular prism. In these examples, the distal end 217 may provide the same contact area regardless of the rotational position of the thermal sleeve 215 about the thermal module axis 208.

In some examples, as shown in FIG. 14E, the portion of the thermal sleeve 215 extending between the proximal end 216 and the distal end 217 is a rectangular prism and the distal end 217 comprises two curved, concave portions, both with a radius of curvature substantially the same as the radius of curvature of the battery cells 150. In these examples, the curves of the two curved, concave portions are segments of cylinders with parallel axes. As shown in FIG. 14E, the distal end 217 may physically contact two battery cells 150 simultaneously when the thermal module axis 208 is equidistant between the battery axis 153 of one of the battery cells 150 and an additional battery axis 154 of another one of the battery cells 150 and the thermal sleeve 215 is rotated about the thermal module axis 208 as shown in FIG. 14E. The distal end 217 shape of FIG. 14E provides a large contact area between the thermal sleeve 215 and the two battery cells 150 when the thermal module axis 208 is equidistant between the battery axis 153 of the two battery cells 150 and the thermal sleeve 215 is rotated about the thermal module axis 208 as shown in FIG. 14E. The distal end 217 shape of FIG. 14E provides thermal contact of the thermal sensor module 205 with two battery cells 150 simultaneously. However, the distal end 217 shape of FIG. 14E provides a smaller contact area when the thermal module axis 208 is closer to one battery axis 153 than to another, or the thermal sleeve 215 is differently rotated about the thermal module axis 208.

In some examples, as shown in FIG. 14F, the portion of the thermal sleeve 215 extending between the proximal end 216 and the distal end 217 is a rectangular prism and the distal end 217 comprises two flat portions, both parallel with a plane that is not parallel with the thermal module axis 208 and not parallel with the plane parallel with the other flat portion. As shown in FIG. 14F, the distal end 217 may physically contact two battery cells 150 simultaneously when the thermal module axis 208 is equidistant between the battery axis 153 of one of the battery cells 150 and the additional battery axis 154 of another of the battery cells 150 and the thermal sleeve 215 is rotated about the thermal module axis 208 as shown in FIG. 14F. The distal end 217 shape of FIG. 14F may provide two contact areas, one with each of two battery cells 150. These contact areas may be lines parallel with the battery axis 153 and the additional battery axis 154 of the battery cells 150 when the thermal sleeve 215 is rotationally oriented about the thermal module axis 208 as shown in FIG. 14F. The distal end 217 shape of FIG. 14F may provide a contact area that varies less with the position of the thermal module axis 208 relative to the battery axis 153 and the additional battery axis 154 of the battery cells 150 than the shape shown in FIG. 14E. However, the contact area may be less when the rotation of the thermal sleeve 215 about the thermal module axis 208 is different than that shown in FIG. 14F.

### Examples of Fabricating Battery Modules Comprising Thermal Sensor Modules

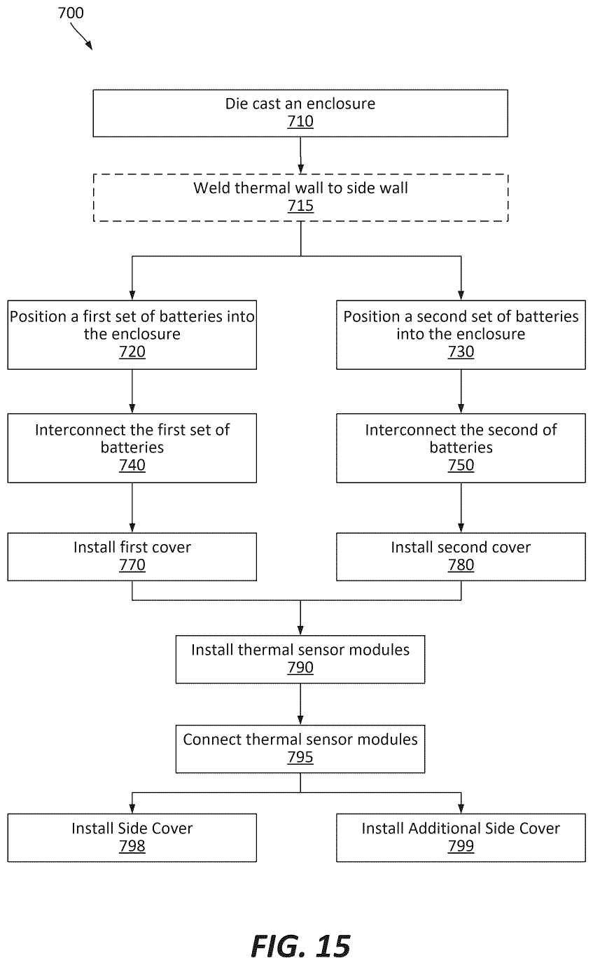

FIG. 15 is a process flowchart corresponding to method 700 of fabricating a battery module 100, in accordance with some examples. Various examples of battery module 100 are described above with reference to FIGS. 12A-14F.

In some examples, method 700 comprises (block 710) die casting an enclosure 110 a first set of side walls 130, a second set of side walls 140, and a second thermal wall 122. In some examples, this die-casting also forms a thermal sensor module opening 251 in the first set of side walls 130. In some examples, this die-casting also forms an additional thermal sensor module opening 253 in the second set of side walls 140. In some examples, this die-casting operation also forms a first thermal wall 121. For example, a casting tool may have one or more dissolvable cores to form a thermal cavity 180. These cores are removed (after the casting) to free up the thermal cavity 180. When multiple dissolvable cores are used, different portions of the thermal cavity 180 may be interconnected as described above with reference to FIGS. 4A and 4B. In some examples, the thermal sensor module opening 251 is formed in the first set of side walls 130 by machining.

Alternatively, the first thermal wall 121 is not formed as a part of this die-casting operation (block 710). Instead, the first thermal wall 121 is formed in a separate operation and later attached to the first set of side walls 130. For example, method 700 may comprise (block 715) friction-stir welding the first thermal wall 121 to the first set of side walls 130 thereby forming the thermal cavity 180 during this welding operation. In these examples, the thermal sensor module opening 251 and the additional thermal sensor module opening 253 may be formed during die-casting to form the first set of side walls 130 or by machining either before or after the welding of the first thermal wall 121 to the first set of side walls 130.

In some examples, method 700 comprises forming insulating surface layers 125 on the external surfaces of the first thermal wall 121 and the second thermal wall 122. For example, plastic sheets may be positioned over these walls. Alternatively, insulating surface layers 125 may be provided in the form of a thermally-conductive epoxy and used to bond the battery cells 150 to their respective thermal walls.

Method 700 may proceed with (block 720) positioning a first set of battery cells 151 into the enclosure 110 or, more specifically, into the first enclosure portion 115. After this operation, the first set of battery cells 151 is surrounded by the first set of side walls 130, which protrude above the first set of battery cells 151. Furthermore, the first set of battery cells 151 is thermally coupled to the first thermal wall 121.

Method 700 may also comprise (block 730) positioning a second set of battery cells 152 into enclosure 110 or, more specifically, into the second enclosure portion 116. After this operation, the second set of battery cells 152 is surrounded by the second set of side walls 140 and thermally coupled to the second thermal wall 122.

Method 700 may proceed with (block 740) interconnecting the first set of battery cells 151 using a first interconnecting assembly 161. Specifically, at least a portion of the first interconnecting assembly 161 can be inserted into the first enclosure portion 115 and, in some examples, attached to the intermediate edge 132 of the first set of side walls 130. As such, this portion of the first interconnecting assembly 161 is surrounded and supported by the first set of side walls 130. The electrical leads of the first interconnecting assembly 161 can be then connected to the electrical terminals of each battery cell in the first set of battery cells 151. The configuration of conductive traces in the first interconnecting assembly 161 determines the connection scheme among the cells. The printed circuit boards 164 can be mechanically coupled to the first set of side walls 130 and the second set of side walls 140 using, for example, threaded connectors or an adhesive. As described above, the printed circuit boards 164 may comprise at least one thermal-sensor-module-board opening 255 that aligns with at least one of the thermal sensor module opening 251 and the additional thermal sensor module opening 253. Method 700 also comprises (block 750) interconnecting the second set of battery cells 152 using a second interconnecting assembly 162. This operation can be similar to the one described above with reference to block 740. In some examples, method 700 further comprises (block 770) installing the first cover 171 and (block 780) installing the second cover 172.

Method 700 may proceed with (block 790) installing the thermal sensor module 205 in the thermal sensor module opening 251. Specifically, installing the thermal sensor module 205 may include rotating the thermal sensor module 205 about the thermal module axis 208 to align the retention tab 240 with PCB keyway 257, applying pressure to the retention tab 240 that causes the retention tab 240 to flex towards the thermal module axis 208, and inserting the thermal sensor module 205 through the at least one thermal-sensor-module-board opening 255 and into the thermal sensor module opening 251. As noted above, the release of pressure from the retention tab 240 allows the retention tab 240 to flex away from the thermal module axis 208, preventing uninstallation of the thermal sensor module 205 from the thermal sensor module opening 251 during subsequent fabrication operations. Optionally, this operation can also include installing the thermal sensor module 205 in the additional thermal sensor module opening 253. This operation can also include installing more than two thermal sensor module s205 in the first set of side walls 130 or installing one or more the thermal sensor module 205 in the additional thermal sensor module opening 253.

Method 700 may proceed with (block 795) connecting the thermal sensor modules 205 with the printed circuit boards 164. Specifically, the thermal sensor connector 235 of one or more of the thermal sensor modules 205 can be connected with the printed circuit boards 164, electrically connecting one or more temperature sensors 210 with the printed circuit boards 164.

Method 700 may proceed with (block 798) installing the side cover 173. Specifically, the side cover 173 can be positioned over the first set of side walls 130 such that openings in the side cover 173 are aligned with fasteners or threaded posts of the first set of side walls 130 and the second set of side walls 140. In some examples, the battery module 100 comprises other alignment features that assist in aligning the side cover 173 with the first set of side walls 130. The side cover 173 can then be mechanically coupled with the 130 using, for example, threaded fasteners or an adhesive. Threaded fasteners provide an advantage in ease of removal for removal and replacement of the side cover 173 for repairs. Adhesives may provide an advantage in less weight contributed to the battery module 100. As described above, installation of the side cover 173 may result in physical contact of the side cover 173 with one or more of the thermal sensor modules 205. This contact may apply pressure to the thermal sensor module housing 220, specifically through pressure applied by the side cover 173 to the thermal sensor module cap 222, to urge the thermal sensor module 205 towards the one or two battery cells 150 of the first set of battery cells 151. Method 700 also comprises (block 799) installing the additional side cover 174 on the second set of side walls 140. This operation can be similar to the one described above with reference to block 798.

### CONCLUSION

Although the foregoing concepts have been described in some detail for purposes of clarity of understanding, it will be apparent that certain changes and modifications may be practiced within the scope of the appended claims. It should be noted that there are many alternative ways of implementing processes, systems, and apparatuses. Accordingly, the present embodiments are to be considered illustrative and not restrictive.

1. A battery module comprising:
an enclosure comprising a first thermal wall, a second thermal wall, and a first set of side walls comprising a thermal sensor module opening, wherein the first set of side walls and the first thermal wall define a first enclosure portion;
a first set of battery cells, positioned within the first enclosure portion, surrounded by the first set of side walls, and thermally coupled with the first thermal wall; and
a thermal sensor module positioned within the thermal sensor module opening and comprising:
a thermal module axis,
a thermal sensor module housing,
a thermal sleeve, at least a portion of which is positioned within the thermal sensor module housing, and
a temperature sensor positioned within and thermally coupled with the thermal sleeve, wherein:
a thermal portion is defined, at least in part, by the first thermal wall and the second thermal wall collectively forming a thermal cavity therebetween, and
the thermal sleeve physically contacts and is thermally coupled with one of the first set of battery cells.

2. The battery module of claim 1, wherein the thermal sensor module opening extends through the first set of side walls, from outside of the enclosure to the first enclosure portion.

3. The battery module of claim 1, wherein the temperature sensor is a negative temperature coefficient thermistor.

4. The battery module of claim 1, wherein the temperature sensor is a bead-type thermistor.

5. The battery module of claim 1, wherein the thermal sensor module further comprises a thermal filler, physically and thermally coupled with both the thermal sleeve and the temperature sensor.

6. The battery module of claim 5, wherein the thermal filler is a thermally-conductive epoxy.

7. The battery module of claim 1, wherein the thermal sensor module housing comprises a retention tab that, when the thermal sensor module housing is positioned in the thermal sensor module opening, applies a force to a portion of the first set of side walls, thereby retaining the thermal sensor module housing within the thermal sensor module opening.

8. The battery module of claim 1, wherein:
the thermal sensor module housing further comprises a thermal sensor module housing opening,
the thermal sleeve is positioned within the thermal sensor module housing opening and is slidably coupled with the thermal sensor module housing,
the thermal sensor module further comprises a thermal sensor module spring positioned within the thermal sensor module housing, and
the thermal sensor module spring is configured to urge the thermal sleeve against the one of the first set of battery cells.

9. The battery module of claim 8, wherein:
the thermal sleeve comprises a distal end positioned outside of the thermal sensor module housing and a proximal end positioned opposite the distal end, and
the proximal end comprises a retention flange having a diameter in a plane orthogonal to the thermal module axis that is larger than a diameter of the thermal sensor module housing opening, thereby preventing the thermal sleeve from uncoupling from the thermal sensor module housing by sliding towards the distal end.

10. The battery module of claim 9, further comprising a thermal sensor module cap, physically contacting the thermal sensor module housing and positioned at an opposite end of the thermal sensor module housing from the thermal sleeve.

11. The battery module of claim 10, further comprising a side cover physically contacting the first set of side walls and at least partially overlapping the thermal sensor module.

12. The battery module of claim 11, wherein the side cover physically contacts the thermal sensor module cap, and the thermal sensor module spring physically contacts the thermal sensor module cap.

13. The battery module of claim 1, further comprising a second set of side walls, wherein:
the second set of side walls and the second thermal wall define a second enclosure portion, and
the second set of side walls comprises an additional thermal sensor module opening.

14. The battery module of claim 1, further comprising a first interconnecting assembly, surrounded and supported by the first set of side walls and interconnecting the first set of battery cells, wherein:
the first set of side walls comprises a top edge and an intermediate edge, each extending parallel to the first thermal wall, and
the intermediate edge is positioned between the top edge and the first thermal wall and supports the first interconnecting assembly.

15. The battery module of claim 14, further comprising a first cover, wherein the first cover is supported on the top edge of the first set of side walls such that at least a portion of the first interconnecting assembly is positioned between the first cover and set of battery cells.

16. The battery module of claim 14, wherein:
the first interconnecting assembly comprises an internal portion comprising bus bars wire-bonded to cell terminals of the first set of battery cells,
the internal portion of the first interconnecting assembly is positioned within the first enclosure portion, surrounded by the first set of side walls, and
the first interconnecting assembly further comprises an external portion, extending outside the first enclosure portion and connected to the bus bars.

17. The battery module of claim 16, wherein the internal portion of the first interconnecting assembly is surrounded and supported by the first set of side walls.

18. The battery module of claim 16, wherein the external portion of the first interconnecting assembly comprises one or more printed circuit boards.

19. The battery module of claim 18, wherein the one or more printed circuit boards are bonded to an external surface of the first set of side walls using a pressure-sensitive adhesive.

20. The battery module of claim 18, wherein:
the thermal sensor module further comprises a sensor wire harness electrically coupled with the temperature sensor and a thermal sensor connector electrically coupled with the temperature sensor,
the thermal sensor module protrudes through at least one of the printed circuit boards, and
the thermal sensor connector is mechanically and electrically coupled with at least one of the printed circuit boards.
